(19) United States
(12) Patent Application Publication
(10) Pub. No.: US 2026/0289253 A1
(43) Pub. Date: Sep. 24, 2026

(54) SYSTEM

(71) Applicant: SoftBank Group Corp., Tokyo (JP)

(72) Inventor: Chihiro MUROI, Tokyo (JP)

(73) Assignee: SoftBank Group Corp., Tokyo (JP)

(21) Appl. No.: 19/558,651

(22) Filed: Mar. 6, 2026

(30) Foreign Application Priority Data
Mar. 19, 2025 (JP) 2025-044527

(51) Int. Cl. G06N 3/0475; G06N 3/0455

(52) U.S. Cl. CPC G06N 3/0475; G06N 3/0455

(57) ABSTRACT

A system includes a processor that is configured to coordinate a personnel management device, a performance evaluation device, a goal setting device, a work progress analysis device, and a machine learning device so as to analyze evaluations, goals, and work progress of employees, generate, by using a generative AI model, a prompt for instructing the generative AI model to perform a specific analysis or prediction based on at least one of the evaluations, the goals, and the work progress of the employees, and cause the generative AI model to execute the analysis or the prediction based on the prompt and to visualize a result of the analysis or the prediction.

### CROSS-REFERENCE TO RELATED APPLICATION

This application is based on and claims priority under 35 USC 119 from Japanese Patent Application No. 2025-044527 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional personnel management systems, performance evaluation systems, goal setting systems, and work progress analysis systems are typically implemented as independent systems that do not sufficiently interoperate with one another. As a result, it is difficult to comprehensively analyze relationships among employee evaluations, individual goals, and actual work progress. Furthermore, even when machine learning techniques are employed, conventional systems generally rely on fixed analysis logic or static rule sets, and do not effectively utilize generative AI models through dynamically generated prompts. Consequently, it is not possible to easily instruct a generative AI model to perform specific analyses or predictions tailored to current personnel and performance data, nor to flexibly change the analysis content according to changing business needs. In addition, existing systems do not adequately support the calculation of relative pseudo-evaluations based on the progress of other division members, and do not provide periodic pseudo-evaluations in a way that effectively enhances user motivation and facilitates managers' ability to manage the growth of subordinates. Therefore, there is a need for a system that integrates multiple management and analysis devices, generates appropriate prompts for generative AI models, performs specific analyses and predictions based on those prompts, and visualizes the results in a form that supports continuous personnel development and performance management, including relative and periodic pseudo-evaluations.

### SUMMARY

To solve the above problems, a system according to one aspect of the present invention comprises a processor, wherein the processor is configured to coordinate a personnel management device, a performance evaluation device, a goal setting device, a work progress analysis device, and a machine learning device so as to analyze evaluations, goals, and work progress of employees. The processor is further configured to generate, by using a generative AI model, a prompt for instructing the generative AI model to perform a specific analysis or prediction based on at least one of the evaluations, the goals, and the work progress of the employees, and to cause the generative AI model to execute the analysis or the prediction based on the prompt and to visualize a result of the analysis or the prediction. In one embodiment, the processor is configured to generate a prompt for calculating a relative pseudo-evaluation based on work progress of other division members and to cause the relative pseudo-evaluation to be calculated based on the prompt, thereby enabling comparison of an employee's performance relative to peers. In another embodiment, the processor is configured to periodically generate a prompt, calculate a pseudo-evaluation based on the prompt, and provide the pseudo-evaluation to a user so as to increase motivation of the user and to facilitate management of growth of subordinates by a manager. By these means, the system can flexibly utilize a generative AI model through dynamically generated prompts, integrate heterogeneous management and analysis devices, and provide both absolute and relative, as well as periodic, evaluation information that supports continuous improvement in personnel development and performance management.

The term “processor” refers to a hardware and/or software processing unit, such as a CPU, GPU, or a combination thereof, including associated control logic and programs, that executes instructions to perform the functions described in the present specification and claims.

The term “personnel management device” refers to a device, system, or module that manages personnel-related information of employees, including at least one of employee identifiers, organizational affiliations, positions, employment status, and other human-resources-related data.

The term “performance evaluation device” refers to a device, system, or module that manages and processes information related to performance evaluations of employees, including evaluation scores, ratings, evaluation periods, evaluation criteria, and comments.

The term “goal setting device” refers to a device, system, or module that manages and processes information related to goals assigned to employees, including target values, goal descriptions, goal periods, and associated metrics.

The term “work progress analysis device” refers to a device, system, or module that collects and analyzes information on the progress of tasks, projects, or work activities of employees, including achievement status with respect to goals, quantitative progress values, and timestamps.

The term “machine learning device” refers to a device, system, or module that executes machine learning processing, including training, inference, and updating of models, to analyze data related to employees' evaluations, goals, and work progress.

The term “generative AI model” refers to an artificial intelligence model, such as a large language model or other generative model, that generates text, numerical outputs, or other data in response to input prompts, and that is used to perform specific analyses or predictions according to instructions provided by a prompt.

The term “prompt” refers to information, typically expressed as text or structured data, that is generated by the processor and provided as input to the generative AI model to instruct the generative AI model to perform a predetermined analysis, prediction, or other processing.

The term “evaluation” refers to performance-related assessment information of an employee, including numerical scores, qualitative ratings, ranks, or other indicators representing performance during a given period or with respect to specific criteria.

The term “goal” refers to a target or objective assigned to or set by an employee, including quantitative targets, qualitative objectives, and associated time frames, which are used as reference points for measuring work progress.

The term “work progress” refers to a state or degree of advancement of an employee's tasks, projects, or activities toward one or more goals, including achieved values, remaining values, and progress rates over time.

The term “relative pseudo-evaluation” refers to an evaluation value calculated for an employee based at least on comparison of the employee's work progress with work progress of other members in a division or group, the evaluation value representing a relative performance position rather than an official or final performance rating.

The term “pseudo-evaluation” refers to an evaluation value that is calculated by the system for analytical, indicative, or interim purposes, which may differ from an official performance evaluation and can be computed periodically or on demand using analysis and prediction by the generative AI model.

The term “visualize” refers to causing analysis or prediction results to be presented in a human-perceivable form, including at least one of graphs, charts, tables, dashboards, or textual summaries, suitable for display on a user interface.

The term “user” refers to any person who interacts with the system through a terminal or other interface, including but not limited to an employee receiving evaluations and goals, and a manager or administrator reviewing evaluations and managing subordinates.

The term “division member” refers to an employee who belongs to a particular organizational unit, such as a division, department, team, or group, and whose work progress is used as a basis for calculating a relative pseudo-evaluation.

The term “manager” refers to a user who has responsibility for overseeing one or more subordinates, including setting goals, reviewing performances, and using pseudo-evaluations to manage and support the growth of said subordinates.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

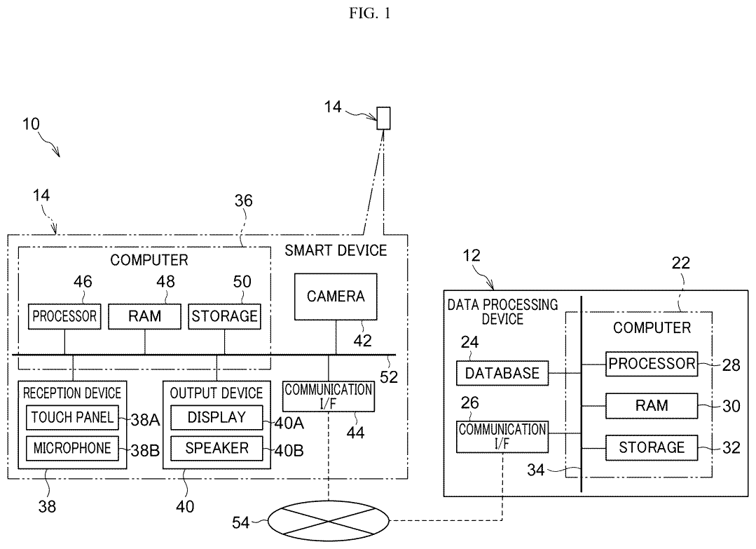

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

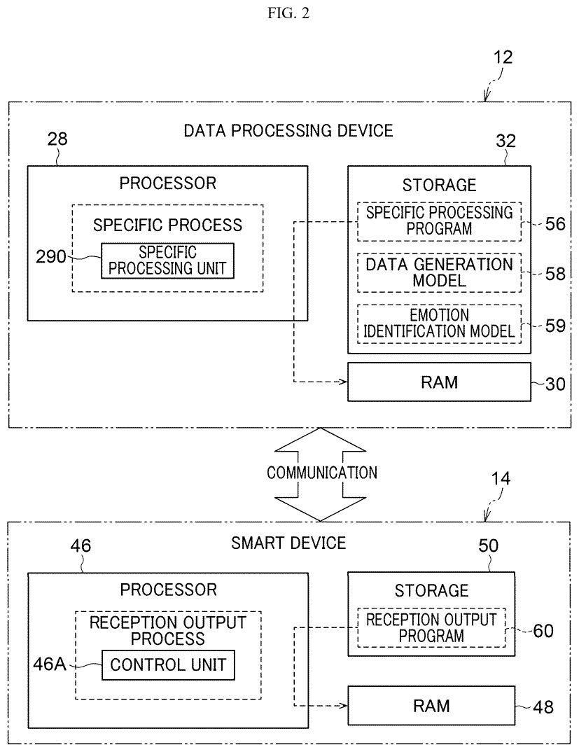

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional personnel and performance management systems typically rely on separate software components for maintaining personnel records, evaluating performance, setting goals, and tracking work progress. These systems often operate in silos, where data is fragmented across multiple databases and applications, and where analytics logic is hard-coded into fixed reporting pipelines. As a result, there are several technical problems.

First, conventional systems lack an integrated data processing architecture that can automatically aggregate heterogeneous data streams (for example, management information, evaluation information, goal information, and progress information) into a unified representation suitable for advanced prediction and explanation. Data ingestion, preprocessing, feature generation, and model inference are often implemented as ad hoc scripts, which leads to high latency, poor scalability, and difficulty in updating or extending the analysis logic.

Second, even when machine learning techniques are applied, they are typically confined to static predictive models whose outputs are delivered as fixed dashboards or reports. The system architecture does not support interactive, context-aware generation of analysis and advice. In particular, the system cannot dynamically generate model inputs or analysis queries in response to user instructions, and cannot flexibly combine structured prediction results with unstructured, natural-language explanations. This limits the ability of the system to adapt its computational behavior to changing user needs and evolving data patterns.

Third, the interface between predictive models and users is usually limited to predefined visualization templates. There is no general mechanism by which a computational model can consume both user instructions and internal analytics context as a machine-readable prompt, and then produce tailored analytic outputs. Without such a mechanism, it is technically difficult to implement a closed-loop process in which user interactions directly drive how analytics are performed, refined, and presented, while maintaining consistency with underlying prediction models and data structures.

Fourth, comparative evaluations among multiple members in an organization, such as relative or pseudo evaluations, are often computed through static aggregation queries that are decoupled from any conversational or generative component. This separation prevents the system from computing normalized comparison metrics and simultaneously generating machine-readable and human-readable explanations that reflect both raw statistics and model-based inferences.

Fifth, existing systems generally lack an architecture for periodic, automated generation of updated evaluations and action proposals in a way that leverages both structured prediction models and generative models. There is no integrated mechanism to continuously refresh stored data, recalculate prediction information, and automatically synthesize new recommendations in natural language, which results in outdated guidance, increased server-side complexity, and inefficient use of computational resources.

Accordingly, there is a need for a computerized system and processing method that (i) unifies heterogeneous organizational data into a consistent analytics substrate, (ii) constructs and applies estimation models to compute prediction information for each member, (iii) programmatically constructs prompt sentences that encode both analytics context and user instructions, and (iv) cooperates with a generative AI model to generate interactive, natural-language analysis and advice. Such a system should technically improve the way in which a processor orchestrates data acquisition, feature generation, model computation, prompt construction, generative inference, and visualization, thereby improving the flexibility, responsiveness, and usability of analytics in an organizational environment.

The specific processing by the specific processing unit 290 of the data processing device 12 in Example 1 is realized by the following means.

The present invention provides a server comprising a processor and a memory storing instructions that, when executed by the processor, cause the processor to acquire, via a communication interface, data groups for each member of an organization from a plurality of external information processing devices including a device that maintains management information of the members, a device that evaluates activity results of the members, a device that sets goals of the members, a device that analyzes work progress of the members, and a device that performs prediction or classification based on a learning algorithm; to integrate the acquired data groups and accumulate the integrated data as stored data in a storage system; to perform data structure conversion processing and feature generation processing on the stored data to construct an estimation model based on the learning algorithm, and to calculate prediction information regarding at least one of goal achievement probability and work efficiency of each member by using the estimation model; to generate, based on the stored data and the prediction information, an analysis context including evaluation indices, goal achievement status, progress status, and risk factors for each member, and to create a prompt sentence including the analysis context and an instruction sentence received from a user; to input the prompt sentence into a generative AI model that generates a response sentence in natural language, and to cause the generative AI model to perform at least one of analysis, explanation, and advice generation based on the analysis context; to generate, based on the response sentence obtained from the generative AI model and the prediction information, visual display data that presents at least one of evaluation results, goal achievement probabilities, work delay risk levels, and improvement proposals for each member by using at least one of graphical elements and list elements, and to provide the visual display data to a terminal device for presentation to the user; and to update, in response to additional user input received from the terminal device, content of the prompt sentence and repeatedly input the updated prompt sentence into the generative AI model to perform interactive analysis or advice generation. This enables technical improvements in computer functionality by providing an integrated processing pipeline in which the server automatically unifies heterogeneous organizational data, constructs and applies predictive models, dynamically synthesizes prompt sentences that embed both structured analytics context and user instructions, and cooperates with a generative AI model to produce adaptive, interactive natural-language outputs, thereby enhancing the efficiency, flexibility, and responsiveness of data analysis and presentation in an information processing environment.

The term “processor” refers to a hardware computation unit, such as a central processing unit or a graphics processing unit, and includes any circuitry or logic configured to execute instructions to perform data processing, control, and communication functions described in this specification.

The term “memory” refers to a hardware storage resource, such as volatile memory or non-volatile memory, configured to store programs, models, parameters, and data used and generated by the processor.

The term “communication interface” refers to a hardware and software combination that enables data exchange between the server and external devices or networks, including wired or wireless network interfaces and associated communication protocols.

The term “storage system” refers to a hardware data storage resource, such as a database system, file system, or distributed storage, configured to persistently store structured or unstructured data, including the stored data described herein.

The term “information processing device” refers to an electronic apparatus including at least a processor and memory, configured to generate, store, or provide data related to organizational members, such as management information, evaluation information, goal information, or progress information.

The term “management information” refers to structured data associated with an organizational member's attributes, such as identification information, affiliation information, role information, and capability information.

The term “activity results” refers to data representing outcomes of tasks, projects, or work performed by an organizational member, including performance scores, quality metrics, or key performance indices.

The term “goal information” refers to data representing target states or objectives assigned to or selected by an organizational member, including goal descriptions, target values, importance levels, and deadlines.

The term “work progress information” refers to data indicating the status of execution of tasks or projects by an organizational member, including completion ratios, remaining work quantities, elapsed times, and delay indicators.

The term “learning algorithm” refers to a computational method or procedure configured to construct a model by using training data, including methods for regression, classification, clustering, or other forms of machine learning.

The term “estimation model” refers to a model constructed by a learning algorithm, configured to output prediction information or classification information based on input features derived from stored data.

The term “prediction information” refers to numerical or categorical values generated by the estimation model, indicating at least one of a goal achievement probability, a work efficiency level, a risk level, or a future performance indicator for a member.

The term “stored data” refers to integrated data accumulated in the storage system, including management information, activity results, goal information, work progress information, derived features, and prediction information for organizational members.

The term “data structure conversion processing” refers to processing that transforms data from one structural form to another, such as joining tables, normalizing or denormalizing records, reshaping arrays, or reformatting fields to enable efficient analysis.

The term “feature generation processing” refers to processing that derives new variables, indicators, or attributes from existing data, including aggregation, normalization, encoding, and calculation of composite metrics, for use as inputs to an estimation model.

The term “analysis context” refers to a structured representation of analytics-related information for a member, including at least evaluation indices, goal achievement status, progress status, and risk factors, prepared for use as part of a prompt sentence.

The term “evaluation index” refers to a numerical or categorical indicator representing a performance-related aspect of a member, such as a performance score, rating level, or derived index computed from activity results.

The term “goal achievement status” refers to information indicating how close a member is to achieving one or more goals, including current progress values, completion flags, and remaining gaps relative to target values.

The term “progress status” refers to information indicating the temporal and quantitative state of ongoing work by a member, including current task states, progression ratios, and schedule adherence.

The term “risk factor” refers to an element derived from stored data or prediction information that indicates a potential cause of underperformance, delay, or failure to achieve a goal, such as persistent backlog, historical delays, or insufficient capacity.

The term “instruction sentence” refers to a text string provided by a user that expresses a request, command, or question to be processed by the system and used in combination with the analysis context to construct a prompt sentence.

The term “prompt sentence” refers to a machine-readable text that includes at least part of the analysis context and at least part of an instruction sentence, and that is configured to be input to a generative AI model in order to cause the model to generate a response sentence.

The term “generative AI model” refers to a trained computational model, such as a neural network-based language model, configured to generate natural language text or other data in response to input prompts.

The term “response sentence” refers to natural language output generated by the generative AI model based on a prompt sentence, including at least one of analysis content, explanations, or advice related to members.

The term “analysis” refers to a process carried out by the generative AI model in which the model interprets and summarizes data, relationships, or trends included in the analysis context and produces explanatory or diagnostic output.

The term “explanation” refers to a natural language description generated by the generative AI model that clarifies reasons, contributing factors, or mechanisms underlying prediction information, evaluation indices, or risk factors.

The term “advice generation” refers to a process in which the generative AI model outputs natural language recommendations or suggested actions to improve goal achievement, work efficiency, or other performance measures.

The term “visual display data” refers to data structures defining how information is presented on a display device, including specifications of graphical elements, list elements, layout, labels, and associated values.

The term “graphical element” refers to a visual component, such as a chart, graph, icon, or shape, used to represent numerical or categorical data for viewing by a user.

The term “list element” refers to a visual component, such as a table row, bullet list item, or textual list entry, used to present a set of related data items in an ordered or grouped manner.

The term “terminal device” refers to an electronic device operated by a user, such as a personal computer, mobile device, or display terminal, configured to transmit input to and receive output from the server.

The term “interactive analysis” refers to a mode of operation in which the server repeatedly generates and updates prompt sentences and obtains corresponding response sentences from the generative AI model in response to successive user inputs.

The term “work delay risk level” refers to a measure, computed from stored data and/or prediction information, indicating a likelihood or degree of delay for tasks or projects associated with a member.

The term “improvement proposal” refers to a recommendation, generated at least in part by the generative AI model, that specifies one or more actions or changes intended to improve a member's goal achievement or work efficiency.

The term “relative evaluation value” refers to a normalized comparison index computed based on data of multiple members, indicating a member's position or ranking relative to other members.

The term “pseudo evaluation value” refers to an evaluation indicator that is periodically or algorithmically computed based on prediction information and other analytics, and that approximates or supplements formal evaluation metrics.

The term “action proposal” refers to a set of concrete actions or behavioral suggestions generated by the generative AI model and presented to a user to guide improvements in work performance or goal achievement.

The term “organization” refers to any group or entity that manages multiple members, such as a company, department, division, or team, for which the system performs the described processing.

In one embodiment, a server implements the claimed system by executing a computer program stored in a memory. The server comprises at least one processor, a main memory, a non-volatile storage device, and a network interface. The server is connected via a communication network to a plurality of external information processing devices and to at least one terminal operated by a user.

The server uses a database management system such as a relational database engine (for example, a system conforming to the SQL standard, such as MySQL), a numerical computation environment such as a Python runtime with data analysis libraries (for example, pandas and scikit-learn), and a visualization engine (for example, a business intelligence tool such as a dashboard generator). The server also uses a generative AI model, such as a large language model implemented on a neural network framework (for example, a transformer-based language model executed by a deep learning framework such as PyTorch or TensorFlow), which is accessible either locally or via a remote model-serving endpoint.

The server acquires, via the network interface, heterogeneous data related to members of an organization from multiple external information processing devices. These devices include, for example, a personnel information device that provides records such as member identifiers, team affiliation, and role; a performance evaluation device that provides scores, ratings, and key performance index values; a goal-setting device that provides representations of targets, deadlines, and weight values; a work progress analysis device that provides task-level status, completion ratios, and delay indicators; and a machine-learning device that provides additional prediction or classification outputs. Each external device provides structured data, typically encoded in formats such as JSON or CSV, via communication protocols such as HTTPS and REST.

The server uses a data ingestion module implemented in Python and a database connector library to parse and validate the incoming data. The server converts incoming records into internal data structures, such as pandas DataFrames. The server normalizes identifiers, enforces data types, and performs referential consistency checks to ensure that each record is correctly associated with a member in a unified schema. By enforcing a consistent schema and by merging data from multiple sources at the server, the system avoids ad hoc data joining at the application level and reduces redundant network calls, thereby decreasing communication overhead and improving data access latency.

The server stores integrated data in the relational database as stored data. The stored data is organized in normalized tables or materialized views that represent, for each member, time-series performance data, goal definitions, goal progress, and work progress. The server defines specific indices, such as indices on member identifiers and dates, to accelerate query performance. This structured storage design allows the server to retrieve feature-relevant subsets of data in fewer disk operations, reducing I/O overhead and improving overall throughput.

The server performs data structure conversion processing and feature generation processing on the stored data by using the data analysis environment. The server uses data-frame operations (for example, grouping, joining, and pivoting) to transform raw data into feature vectors suitable for machine learning. For example, the server computes, for each member:
A moving average of performance ratings over a predefined number of periods.
A goal achievement ratio defined as current progress divided by target value for each active goal.
Count and ratio of overdue tasks within a defined time window.
Aggregated workload features, such as total assigned hours per week or number of concurrent projects.

The server may encode categorical variables, such as department and role, by using one-hot encoding or target encoding, and may normalize numerical variables by using techniques such as z-score normalization or min-max scaling. Because the server implements these transformations systematically at the data-frame level and applies them uniformly to historical and current data, the system reduces the risk of inconsistent feature definition and improves the reproducibility of model training and inference.

The server constructs estimation models based on machine-learning algorithms. In one embodiment, the server uses a regression algorithm, such as a random forest regressor, to predict a future performance score or work efficiency index, and a classification algorithm, such as logistic regression or gradient boosting, to estimate a probability that a member will achieve all active goals within specified deadlines. The server splits data into training and validation subsets and optimizes hyperparameters through search strategies such as grid search or randomized search.

The server defines a loss function appropriate to each model type. For a regression model, the server may use mean squared error as the loss function and for a classification model, the server may use cross-entropy loss. During training, the server iteratively updates model parameters to minimize the loss. When the model is implemented as a deep neural network, such as a feed-forward network, the server uses backpropagation with gradient-based optimizers (for example, Adam or stochastic gradient descent) to update weight parameters. By structuring models and training loops in this way, the server achieves improved prediction accuracy over simple rule-based or linear methods, and the system's prediction error is reduced, which in turn increases the reliability of subsequent advice.

The server stores trained model parameters either in the same relational database or in a model repository within the non-volatile storage device. When new data arrives or when a user requests analysis, the server loads the appropriate model and computes prediction information for each relevant member. For example, the server outputs, for a given member, a vector of probabilities corresponding to different goals, an expected performance index for the next period, and a computed work delay risk level derived from predicted completion times and historical delay patterns.

The server generates an analysis context for each member by combining stored data and prediction information. The analysis context is instantiated as a structured text or data object containing at least evaluation indices, goal achievement status, progress status, and risk factors. The server may compute additional derived indicators, such as trend directions (increasing, stable, decreasing) by applying slope estimations or difference calculations to time-series data. This analysis context is designed to include only the most relevant features for the member and to be compact enough to be efficiently passed to a generative AI model, thereby reducing the size of prompt payloads and diminishing network latency when the generative AI model is hosted remotely.

The server receives an instruction sentence from the user via the terminal. The terminal is, for example, a personal computer, a tablet, or a smartphone that executes a web browser or a dedicated application. The user inputs an instruction sentence in natural language through a text input field. Examples of such instruction sentences include:
“Explain my current goal achievement risks and suggest three concrete actions to improve my success probability.”
“How can I restructure my weekly tasks to increase the likelihood of completing Project Gamma on time?”
“Compare my current performance and goal progress with the average of other members in my department and explain the differences.”
“What specific actions should I prioritize over the next two weeks to increase my probability of achieving all my goals above 80%?”
“Explain why my success probability for Project Beta is only 55%, and list three concrete actions that would most effectively raise it above 75%.”

The server constructs a prompt sentence by combining the analysis context generated for the member and the instruction sentence received from the user. In one embodiment, the server places the analysis context and the instruction sentence into a structured template, including labels such as “Employee profile,” “Recent performance,” “Current goals,” “Model predictions,” and “User question.” The server can enforce a fixed ordering and delimitation tokens so that the generative AI model can reliably parse the prompt structure. This prompt construction process is not a mere concatenation of strings, but a structured encoding of machine-generated analytics and user-provided instructions into a single sequence, which enables the generative AI model to correctly associate explanation content with quantitative indicators.

The server inputs the prompt sentence into the generative AI model. In one embodiment, the generative AI model is a transformer-based language model characterized by multiple self-attention layers, feed-forward layers, and layer normalization components. The generative AI model has been pre-trained on large corpora of text and may be further fine-tuned with domain-specific data, such as anonymized organizational performance narratives and explanation patterns. The server invokes the generative AI model through an inference API, specifying parameters such as temperature, maximum output length, and presence or frequency penalties to control the diversity and detail of generated text.

Internally, the generative AI model represents the prompt sentence as token sequences, computes contextualized embeddings using self-attention operations, and generates probability distributions over vocabulary tokens for each output position. The server receives the token sequence representing a response sentence and decodes it into natural language text. Because the prompt sentence contains both quantitative indicators and explicit labels, the generative AI model can learn non-trivial mapping patterns between quantitative features and explanation structures, enabling it to generate nuanced analyses that go beyond simple repetition of input data.

The server uses the response sentence, together with prediction information, to generate visual display data. The server configures a visualization engine or web rendering layer to map key variables to appropriate graphical elements. For instance, the server defines line charts for time-series ratings, bar charts for goal completion percentages, and color-coded indicators for risk levels. The server also generates list elements that present the main points of the response sentence, such as a numbered list of recommended actions. By generating both graphics and textual summaries from a shared data context, the server maintains consistency between visual and textual outputs.

The server transmits the visual display data to the terminal via the network interface. The terminal renders the visual display data on a display unit. The user can view graphs and lists while reading the response sentence generated by the generative AI model. The user can then input additional questions or modifications, such as narrowing the time window, emphasizing particular goals, or requesting alternative scenarios. The terminal sends each new instruction sentence to the server.

The server updates the prompt sentence content based on the additional user input. In one embodiment, the server appends interaction history and updated analysis context into a conversation-oriented prompt, so that the generative AI model can produce context-aware follow-up responses. In another embodiment, the server partially rebuilds the analysis context by re-querying stored data or recomputing predictions when the user changes parameters such as time horizon or target goal set. By handling these reconstructions at the server side with structured data operations, the system avoids transmitting large raw data batches over the network for each interaction and thus reduces communication bandwidth usage.

The server may implement specific algorithms for relative or pseudo evaluation among multiple members. For example, the server computes, for each member, a relative evaluation value defined as a z-score or percentile rank of a performance indicator within a group of peers having the same role or department. The server uses statistical aggregation functions and normalization operations directly on the relational database or on data frames to produce these values. The server then includes these relative evaluation values and their associated factors into the analysis context, enabling the generative AI model to output explanations that reference comparative standings and group-level patterns.

The server can also periodically update stored data and prediction information at predetermined intervals, such as daily or weekly. On each update cycle, the server retrieves newly ingested data, recomputes feature vectors, re-applies estimation models, and generates updated prediction information. The server constructs new prompt sentences that include pseudo evaluation values and updated action proposals. The server may then trigger background generation of response sentences and proactively push updated visual display data to terminal devices or make such data available through a dashboard interface. This periodic processing allows the system to maintain up-to-date analyses while avoiding unnecessary computation for every user interaction.

The use of this integrated architecture yields several technical effects. Because the server centralizes data ingestion, feature generation, model inference, prompt construction, and generative inference, the number of disparate scripts and tools is reduced, leading to fewer data format conversions and reduced risk of inconsistency. The server's use of structured schemas and indices improves query performance, thereby reducing latency for both batch and interactive operations. The server's feature generation process leverages vectorized operations, which increases computational efficiency over naive per-record loops.

Furthermore, the combination of estimation models and generative AI models, orchestrated by the server, represents more than mere automation of human reading and writing tasks. The server uses machine-optimized parameter sets and structured prompts to exploit patterns across large historical datasets that cannot feasibly be identified by manual inspection. The estimation models provide quantitative predictions with measured error characteristics, and the generative AI model transforms these predictions and features into explanations and recommendations that are directly aligned with the underlying data. The server thereby improves the accuracy and consistency of explanations compared to ad hoc human analyses and reduces human bias in interpreting metrics.

In another embodiment, the server deploys the generative AI model locally on a high-performance computing node equipped with graphics processing units. The server manages model loading, caching, and batch inference to share the model among multiple user sessions. The server groups multiple prompt sentences into inference batches, reducing per-request overhead and improving throughput. The server may also compress prompt and response payloads to further reduce network traffic between the server and remote model endpoints. These optimizations result in shorter response times and lower resource utilization, which constitute improvements in computer operation.

In a variant embodiment, the server uses a gating mechanism to choose between multiple generative AI models depending on the content of the instruction sentence and the complexity of the analysis context. For short, focused queries, the server may select a smaller model with fewer parameters, which consumes fewer compute resources, while for complex, multi-faceted queries, the server may select a larger model capable of more sophisticated reasoning. This adaptive model selection is based on programmatic evaluation of instruction length, number of goals involved, or diversity of features in the analysis context. By doing so, the server reduces average computational cost without degrading quality for complex tasks.

In another variant embodiment, the server augments the training of the generative AI model or a fine-tuned version thereof by using synthetic examples derived from stored data. The server constructs prompt-response pairs in which the prompt contains structured analysis contexts and the response contains idealized explanations and recommendations. The server uses these pairs to fine-tune model parameters by minimizing a loss function such as cross-entropy on output tokens. This training is performed with gradient-based optimization and may involve regularization techniques such as dropout or weight decay. As a result, the generative AI model becomes more sensitive to the specific structure of the analysis context and produces more accurate and concise explanations, which further enhances the technical value of the system.

The terminal operates primarily as a presentation and input device, but it may perform certain client-side tasks to reduce server load, such as caching static visual assets, pre-rendering charts based on precomputed data, and validating user input format before sending instruction sentences. The terminal can also maintain a local representation of interaction history to provide the user with a smooth interface, even if the server is processing several requests concurrently.

The user operates the terminal to access the system, review visual display data, and provide instruction sentences. The user does not need to understand internal data structures or model algorithms. The system is therefore able to expose advanced machine learning and generative capabilities in a usable manner, while the technical complexity remains within the server components. By encapsulating the data-processing pipeline and providing standard interfaces between modules, the server achieves a modular and extensible architecture that can adapt to various organizational environments and data sources.

Through these embodiments and variations, the system realizes an improvement in computer technology itself, rather than merely automating a pre-existing human evaluation workflow. The server manages complex data flows, coordinated model executions, and dynamically structured prompt construction, which together improve prediction accuracy, reduce processing latency, optimize computation and communication resources, and enable flexible, interactive analytics that are not achievable by conventional, rigid reporting systems.

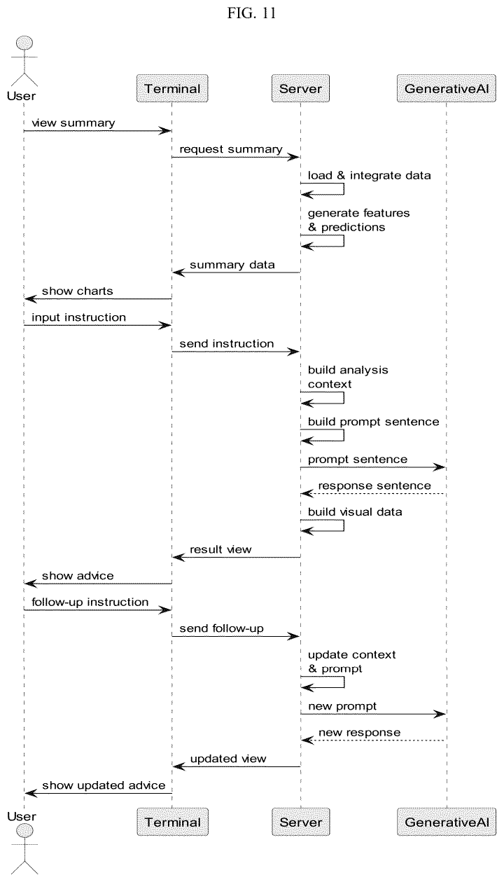

The following describes the processing flow using FIG. 11.

### Step 1:

The server acquires source data from external information processing devices.

The server receives, as input, structured data records from a personnel information device, a performance evaluation device, a goal-setting device, a work progress analysis device, and optionally a machine-learning device, via a network interface using protocols such as HTTPS and REST.

The server parses the incoming payloads (for example, JSON or CSV) and validates required fields such as member identifiers, timestamps, scores, goal identifiers, and status codes. The server performs type checking, normalizes date formats, and logs any malformed or missing fields.

The server outputs normalized in-memory structures (for example, row objects or data frames) in which each record is associated with a canonical member identifier and a source type (personnel, evaluation, goal, progress, or prediction).

### Step 2:

The server integrates the normalized data into stored data in a database.

The server receives, as input, the normalized in-memory structures generated in Step 1.

The server performs data integration by joining or linking the records on member identifiers, device-specific keys, and timestamps. The server maps each record into database tables defined for members, evaluations, goals, work progress, and auxiliary prediction data. The server executes insert and update operations through a database connector, applying de-duplication rules (for example, ignoring older records when a newer one with the same key exists).

The server outputs an updated database state in which all received data is stored as “stored data” in normalized or partially denormalized tables, indexed by member, time, and data category.

### Step 3:

The server loads stored data required for analytics into an analysis environment.

The server receives, as input, a set of selection criteria, such as a time window or a subset of members, either from system configuration or from user context.

The server executes database queries that select relevant rows from the member, evaluation, goal, and work progress tables. The server transfers the result sets into an analysis environment (for example, a data-frame structure in memory). The server may also load any existing prediction or classification outputs stored in auxiliary tables.

The server outputs in-memory analysis tables, each representing a category of data (for example, member profiles, evaluation histories, goal definitions, and progress logs) for the selected members and time periods.

### Step 4:

The server performs data structure conversion and feature generation.

The server receives, as input, the in-memory analysis tables generated in Step 3.

The server converts data structures by performing operations such as joins, aggregations, and reshaping. For example, the server aggregates evaluation records to compute moving averages, pivots goal records to create per-goal columns, and aggregates progress records to compute counts of overdue tasks per member. The server then generates features by calculating new values, including ratios (for example, progress/target), differences (for example, current score minus previous score), trend indicators (for example, sign of slope), and encoded categorical variables (for example, one-hot encoded department indicators).

The server outputs a feature matrix in which each row corresponds to a member (and optionally a time slice) and each column corresponds to a derived feature value that will be used as input to estimation models.

### Step 5:

The server computes prediction information using estimation models.

The server receives, as input, the feature matrix generated in Step 4 and the parameters of one or more estimation models stored in the system.

The server applies the estimation models by performing numerical computations on the feature vectors. For a regression model, the server multiplies feature vectors by learned weights, applies non-linear transformations if present, and produces predicted continuous scores such as future performance indices. For a classification model, the server computes class probabilities (for example, probability of goal achievement) using logistic or softmax transformations. If the model is a tree-based ensemble, the server evaluates decision trees and aggregates their outputs.

The server outputs prediction information for each member, including at least one of predicted performance scores, goal achievement probabilities, and work delay risk levels. The server may store these outputs back into the database as prediction records associated with the corresponding members and time references.

### Step 6:

The server generates an analysis context for each member.

The server receives, as input, the stored data (member profiles, evaluations, goals, progress) and the prediction information produced in Step 5.

The server selects and formats key indicators for each member, such as recent average ratings, current goals and their progress ratios, numbers of overdue tasks, predicted goal achievement probabilities, and identified risk factors (for example, repeated delays). The server may compute additional comparative metrics, such as relative evaluation values normalized within a peer group. The server then organizes these values into a structured representation, for example, a labeled text or key-value mapping that explicitly names each indicator.

The server outputs, for each member, an analysis context object that encapsulates the processed numeric and categorical information in a deterministic structure suitable for later embedding into a prompt sentence.

### Step 7:

The terminal acquires and displays summary information to the user.

The terminal receives, as input, visual display data or summary indicators transmitted by the server based on the analysis context and prediction information.

The terminal renders charts, tables, and key figures on a display device, using a web browser or client application. The terminal may present simplified views, such as a list of current goals with progress bars and a numeric success probability for each member the user is authorized to see. The terminal also presents an input field that allows the user to submit an instruction sentence for deeper analysis.

The terminal outputs a visual presentation of the member's status and provides an interface through which the user can initiate interaction with the generative AI model.

### Step 8:

The user inputs an instruction sentence and requests analysis or advice.

The user receives, as input, the displayed summary information and the input field from the terminal.

The user analyzes the displayed information and types an instruction sentence in natural language expressing a request. Example instruction sentences include:
“Explain my current goal achievement risks and suggest three concrete actions to improve my success probability.”
“How can I restructure my weekly tasks to increase the likelihood of completing Project Gamma on time?”
“Compare my current performance and goal progress with the average of other members in my department and explain the differences.”
“What specific actions should I prioritize over the next two weeks to increase my probability of achieving all my goals above 80%?”
“Explain why my success probability for Project Beta is only 55%, and list three concrete actions that would most effectively raise it above 75%.”

The user triggers a send operation, for example by pressing a button or hitting a key. The user outputs, through the terminal, the instruction sentence as user input to the system.

### Step 9:

The terminal sends the instruction sentence and context identifiers to the server.

The terminal receives, as input, the instruction sentence entered by the user and local context information (for example, currently selected member, project, and time range).

The terminal constructs a message containing the instruction sentence, a user identifier, and context identifiers. The terminal may perform client-side validation, such as checking that the instruction is non-empty and encoding text in a specified character set. The terminal then transmits the message to the server via a network protocol such as HTTPS.

The terminal outputs a request packet that carries the instruction sentence and context metadata to the server for further processing.

### Step 10:

The server constructs a prompt sentence from the analysis context and the instruction sentence.

The server receives, as input, the request packet from the terminal containing the instruction sentence and context identifiers.

The server uses the context identifiers to retrieve the appropriate analysis context object for the relevant member from memory or from the database. The server then formats the analysis context into a textual representation, for example by labeling sections such as “Profile,” “Recent Performance,” “Current Goals,” and “Predictions,” and by inserting numerical values into template sentences. The server concatenates or otherwise combines this formatted analysis context with the instruction sentence according to a predefined structure, possibly adding separators, headings, or markers that the generative AI model is trained to understand.

The server outputs a prompt sentence that encodes both the analytics-derived context and the user's request in a single text sequence ready to be processed by the generative AI model.

### Step 11:

The server invokes the generative AI model with the prompt sentence.

The server receives, as input, the prompt sentence constructed in Step 10.

The server sends the prompt sentence to a generative AI model, either running locally or accessible via a remote inference endpoint. The server may include additional control parameters such as temperature, maximum output length, and stop conditions. Internally, the generative AI model tokenizes the prompt sentence, computes contextual embeddings using transformer layers, and generates probabilities for response tokens step-by-step. The server awaits the completion of the model's generation process.

The server outputs a response sentence in natural language, obtained from the generative AI model, that contains at least one of analysis results, explanations of prediction information, and action-oriented advice for the member.

### Step 12:

The server post-processes the response sentence and prepares visual display data.

The server receives, as input, the response sentence produced in Step 11 and the prediction information and analysis context previously used to construct the prompt sentence.

The server may parse the response sentence to identify key segments, such as lists of recommended actions or explanations of specific metrics, by using pattern recognition or simple delimiters if the prompt requested structured output. The server then maps these segments, along with numeric prediction values, into visual display data. The server configures graphical elements such as charts and icons to represent numerical data, and generates list elements that display the recommended actions and explanations in an ordered fashion.

The server outputs a composite visual display data structure that includes both graphical representations and formatted text derived from the response sentence and the underlying prediction information.

### Step 13:

The terminal displays the analysis result and advice to the user.

The terminal receives, as input, the visual display data structure transmitted by the server.

The terminal renders charts, graphs, and lists according to the received specifications. For example, the terminal displays a bar chart showing predicted success probabilities for each current goal and a numbered list presenting the recommended tasks and their rationales. The terminal may highlight portions of the response sentence that correspond to high-risk items or high-impact recommendations.

The terminal outputs an updated user interface in which the user can visually inspect both quantitative metrics and natural-language explanations generated by the generative AI model.

### Step 14:

The user optionally provides additional input for interactive refinement.

The user receives, as input, the displayed charts, explanations, and recommendations on the terminal.

The user reviews the content and decides whether additional clarification or alternative analysis is needed. The user may input a follow-up instruction sentence, such as “Adjust these actions to fit only 10 hours per week” or “Give me a daily schedule for the next five days based on your recommendations.” The user again triggers transmission of this new instruction sentence.

The user outputs refined or additional instruction sentences that prompt further interactive analysis by the system.

### Step 15:

The server updates the prompt sentence and repeats generative processing based on new user input.

The server receives, as input, the additional instruction sentence from the terminal and may also receive updated context preferences such as time constraints or altered priorities.

The server updates the analysis context if necessary, for example by recalculating workload features under a new time constraint or by filtering goals according to user selections. The server then constructs an updated prompt sentence that includes the revised analysis context and incorporates the latest instruction sentence, optionally together with a representation of previous interactions for continuity. The server sends the updated prompt sentence to the generative AI model, receives a new response sentence, and again prepares corresponding visual display data.

The server outputs new analysis and advice results that reflect the user's additional constraints or questions, thereby realizing interactive refinement of analytics and recommendations through repeated cycles of data-driven prompt sentence construction and generative AI model inference.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional workforce management systems mainly aggregate and visualize human resource data such as evaluations, goals, and work progress, but they do not adequately improve the operation of the underlying computer technology that processes such data. In particular, these systems typically: (i) treat heterogeneous human resource related data streams as static records, (ii) apply fixed, non-adaptive rules or batch analytics, and (iii) output generic dashboards or reports that are not optimized for real-time, context-aware guidance to individual workers. As a result, the computing infrastructure fails to exploit dynamic feedback loops between sensed work context, machine-learned analysis, and user interaction, and therefore cannot provide timely, personalized, and computationally efficient assistance in complex work environments.

Furthermore, existing systems that employ machine learning or predictive models usually embed the models in a rigid pipeline: structured data is preprocessed, a model is called with a fixed input schema, and a prediction is returned. Such pipelines lack a mechanism whereby the processor can automatically construct, update, and refine machine-consumable instructions, such as prompt sentences for a generative AI model, based on continuously updated work efficiency indicators and user interaction logs. Without such dynamic prompt generation and refinement, the computer cannot flexibly adapt the content and granularity of model inputs to the current context, leading to suboptimal use of the model's capabilities and unnecessary computational overhead.

Additionally, known wearable or heads-up display systems for industrial use generally operate as passive clients that present static instructions or pre-authored workflows. They do not form part of an integrated computing loop in which the terminal's interaction events and progress signals are treated as first-class data inputs that continuously modify the state of the server-side analytics and prompting logic. Consequently, the overall computer system does not optimize how data is collected, transformed, and fed into AI models, nor how AI outputs are segmented, prioritized, and scheduled for display, and thus cannot achieve efficient, real-time adaptation of the guidance content.

In summary, there is a need for an improved computer-implemented system in which a processor: (i) unifies heterogeneous human resource related information into machine-usable unified data, (ii) computes work efficiency indicators in real time, (iii) dynamically constructs and refines prompt sentences for a generative AI model based on these indicators and feedback from a terminal, and (iv) converts model outputs into structured, prioritized display control data optimized for wearable visual devices. Such a system should implement a closed-loop, technically specific control flow that improves how computers process, route, and transform data for interactive, AI-driven work support, thereby enhancing processing efficiency, responsiveness, and adaptability of the underlying computing infrastructure.

The specific processing by the specific processing unit 290 of the data processing device 12 in Application Example 1 is realized by the following means.

The present invention provides a server comprising a processor configured to acquire human resource related information from an information processing apparatus group and integrate the human resource related information into unified data, compute work efficiency indicators based on the unified data and identify delay degrees and problem locations for each work unit or work process unit, dynamically generate a prompt sentence for a generative AI model according to the work efficiency indicators and the problem locations and transmit input data including the prompt sentence to the generative AI model, analyze output information obtained from the generative AI model, divide work procedure information and improvement proposal information into instruction units expressed as short sentences, convert the instruction units into display control data by assigning priority information and display time information to each instruction unit, transmit the display control data to a terminal apparatus including a portable visual display apparatus and cause the terminal apparatus to sequentially display the work procedure information and the improvement proposal information within a worker's field of view, acquire operation information and progress information of the worker transmitted from the terminal apparatus, recompute the work efficiency indicators using the operation information and the progress information, update contents of the prompt sentence, re-execute input of the updated prompt sentence to the generative AI model so as to update advice contents in real time, and compare the work efficiency indicators before and after application of advice provided by the generative AI model, and create, based on a comparison result, another prompt sentence for generating further improvement proposal information and input the another prompt sentence to the generative AI model. This enables the computer system to implement a concrete, closed-loop control architecture in which heterogeneous workforce data is transformed into unified metrics, dynamically encoded into model-specific prompt sentences, processed by a generative AI model, and converted into structured display control data that is continuously refined based on terminal-side interaction and progress feedback, thereby improving the technical performance of data processing, responsiveness, and adaptability of the underlying computing platform for real-time, AI-driven work guidance.

The term “system” refers to a combination of one or more computing devices and one or more terminal devices that cooperatively execute the functions described in the claims.

The term “server” refers to an electronic computing apparatus including at least one processor and at least one memory, configured to execute programs for performing the data acquisition, analysis, prompt generation, and communication functions described herein.

The term “processor” refers to one or more hardware processing units, such as a central processing unit or a graphics processing unit, capable of executing instructions stored in a memory to implement the described operations.

The term “information processing apparatus group” refers to a plurality of electronic devices or subsystems that acquire, store, or output human resource related information, including but not limited to personnel management systems, performance evaluation systems, goal setting systems, and work progress analysis systems.

The term “human resource related information” refers to data associated with individuals involved in work, including evaluations, goals, work assignments, work progress records, error records, time stamps, and other attributes relevant to human resource management.

The term “unified data” refers to data that has been converted from heterogeneous formats into a common schema or representation that allows consistent processing across different data sources.

The term “work efficiency indicators” refers to quantitative or qualitative metrics derived from unified data for evaluating efficiency of work, including but not limited to processing time per task, delay ratios, completion rates, and error frequencies.

The term “delay degree” refers to an amount or ratio by which an actual progress or time required for a work unit deviates from a planned progress or target time.

The term “problem location” refers to a specific work unit, work process unit, task step, or condition identified as contributing to reduced work efficiency or increased error occurrence.

The term “work unit” refers to a discrete portion of work, such as a task, subtask, or operation, that can be individually measured and evaluated.

The term “work process unit” refers to a sequence or stage of work operations, such as a process step or phase in a workflow, that can be distinguished from other sequences or stages.

The term “generative AI model” refers to a machine learning model that receives an input including a prompt sentence and automatically generates output information such as text representing analysis, predictions, or recommendations.

The term “prompt sentence” refers to a text or text-like instruction, including natural language and optionally embedded structured data, that is provided as input to a generative AI model to cause the model to perform a specific analysis, prediction, or content generation.

The term “input data including the prompt sentence” refers to data transmitted to the generative AI model, composed at least of a prompt sentence and optionally additional parameters or context information.

The term “output information obtained from the generative AI model” refers to information, such as text or structured data, generated by the generative AI model in response to input data including the prompt sentence.

The term “work procedure information” refers to information representing a sequence or method of performing work, including an ordering of steps, operational instructions, and recommended actions.

The term “improvement proposal information” refers to information representing suggested changes or enhancements to a work procedure, work environment, or worker behavior aimed at improving efficiency, accuracy, or safety.

The term “instruction unit” refers to a minimal unit of guidance, expressed as a short sentence or phrase, that can be individually displayed to a worker and followed as a discrete instruction.

The term “display control data” refers to data that defines contents, priority, timing, and other parameters for presenting information on a display, including fields for instruction unit text, priority information, and display time information.

The term “priority information” refers to data specifying a relative importance or display order of instruction units in relation to each other.

The term “display time information” refers to data specifying a duration, timing, or schedule for presenting each instruction unit on a display.

The term “terminal apparatus” refers to an electronic device operated by or carried by a worker, configured to communicate with the server and present information to the worker.

The term “portable visual display apparatus” refers to a wearable or handheld device capable of visually presenting information in a worker's field of view, including but not limited to smart glasses and head-mounted displays.

The term “worker's field of view” refers to a visual region observable by a worker when the worker is using the portable visual display apparatus.

The term “operation information” refers to data representing operations performed by a worker or interactions with the terminal apparatus, including gestures, touch inputs, voice commands, or other user interface actions.

The term “progress information” refers to data indicating a current state of work execution, including task completion status, current step number, elapsed time, and other indicators of work progress.

The term “advice contents” refers to explanatory or prescriptive information, derived from the generative AI model output, that suggests actions, sequences, or improvements for the worker.

The term “pseudo evaluation value” refers to a computed metric that approximates an evaluation of performance or achievement, based at least in part on relative comparison among multiple members rather than on absolute evaluation criteria.

The term “relative work achievement degree” refers to a measure of work progress or performance of one member compared to that of other members.

The term “relative pseudo evaluation information” refers to information representing pseudo evaluation values for multiple members, derived from relative work achievement degrees and optionally formatted for presentation to a user.

The term “user” refers to a person who receives information from the system, including but not limited to a worker, a manager, or another stakeholder.

The term “manager” refers to a user responsible for overseeing or managing other members, including evaluating growth, performance, or progress.

The term “growth management” refers to activities of monitoring and supporting improvement of skills, performance, or efficiency of members over time, using information provided by the system.

The term “predetermined cycle” refers to a time interval or schedule specified in advance or dynamically configured, at which the processor repeatedly executes generation of prompt sentences and analysis or prediction by the generative AI model.

In one embodiment, a server, a terminal, and a user cooperate to implement the claimed system. The server includes at least one processor, a main memory, a non-volatile storage device, and a communication interface. The server operates on general-purpose server hardware, such as an x86-compatible central processing unit, volatile memory, and a solid-state storage device, and runs a multitasking operating system such as a server-oriented operating system. The server executes server-side application software implemented, for example, using a programming language and a web framework. The server additionally communicates over a data network, such as an IP-based network, with one or more external information processing apparatuses that provide human resource related information.

The server acquires human resource related information from a plurality of information processing apparatuses, such as a personnel management system, a performance evaluation system, a goal setting system, and a work progress analysis system. The server receives such information in heterogeneous formats, such as structured messages, and stores the received messages in a persistent storage device. The server then converts the heterogeneous data into unified data by mapping fields to a unified schema, such as a relational schema with tables for workers, tasks, goals, performance metrics, and time-stamped events. By converting the data into the unified schema, the server reduces the computational overhead of later queries and allows the processor to execute vectorized operations on indexed columns, which improves data access speed and reduces memory usage during analysis.

The server uses a database management system, such as a relational database system, to manage the unified data. The server defines tables for employee identifiers, task identifiers, step identifiers, time stamps, completion flags, error codes, and target metric values. The server defines indexes on combinations of columns, such as (employee_id, timestamp) and (task_id, step_id), to support fast retrieval of per-worker and per-task histories. The server thereby reduces the complexity of data joins and decreases the latency of computing work efficiency indicators.

The server computes work efficiency indicators by executing numerical operations over the unified data. For example, the server computes, for each worker and each task step, an average processing time, a variance of processing time, an on-time completion ratio, and an error frequency. The server also computes a delay degree by subtracting a target time from an actual average time and normalizing the result by the target time. The server identifies problem locations by detecting steps where the delay degree exceeds a threshold, or where error frequency surpasses a predefined rate. These indicators are stored in memory as feature vectors associated with a worker-task-step tuple, allowing the server to construct structured input for subsequent machine learning processing.

The server uses these feature vectors to generate a prompt sentence for a generative AI model. The server implements a prompt construction module that receives as input the computed work efficiency indicators, identifiers of problem locations, and contextual information such as task descriptions and current step numbers. The server applies deterministic rules to select which metrics to mention and how to represent them in natural language. The server, for example, embeds numeric values into a template that describes the current state, performance gaps, and constraints on the desired output from the generative AI model. The server thereby converts internal numerical state into a text-based query that characterizes the current work context in a way that can be consumed by the generative AI model.

In one example, the server constructs the following prompt sentence:
“The worker is assembling product X and is currently at step 3 of 5.
Average time for step 3 today: 4.1 minutes.
Target time per step: 3.0 minutes.
Frequent problem: misalignment of part B with shaft A.
Using this information, generate 3 short, concrete instructions to improve efficiency and reduce errors. Each instruction must be under 25 words and suitable for display on smart glasses.”
In another example, the server constructs a prompt sentence for daily performance analysis:
“Using the following daily performance summary for the worker:
Planned tasks: 20.
Completed tasks: 17.
Average completion time per task: 14 minutes.
Goal: 12 minutes per task without compromising quality.
Analyze the data and propose a prioritized list of process improvements and scheduling adjustments that can help the worker meet the goal tomorrow. Format the answer as bullet points, each under 40 words.”

The server provides such prompt sentences, along with optional structured context, to a generative AI model executing on the server or another computing node integrated with the server. The generative AI model is, in one embodiment, a neural network model implemented using a deep learning framework. The generative AI model may be a transformer-based neural network including an embedding layer, multiple self-attention layers, feed-forward layers, and a final projection layer that outputs a probability distribution over tokens. The neural network is trained using supervised learning on a large corpus of text data and instruction-following pairs, using a loss function such as cross-entropy between predicted token distributions and reference tokens.

The server trains or fine-tunes the generative AI model using an optimizer such as stochastic gradient descent or a variant thereof, such as Adam. During training, the server iteratively updates model weights to minimize the loss function by backpropagation through the network. The server computes gradients of the loss function with respect to each parameter in the model, aggregates gradients over mini-batches of training examples, and adjusts the weights according to the chosen optimizer. The server may apply techniques such as learning rate scheduling, gradient clipping, and regularization to improve convergence and generalization. In some embodiments, the server applies data augmentation procedures, such as paraphrasing and partial masking of instructions, to increase the robustness of the model to varied prompt sentences.

The server uses the generative AI model not as an opaque component, but in a specific, technically constrained manner. The server controls input length, tokenization, and prompt structure to reduce computation time and memory usage. The server, for example, truncates irrelevant historical context, compresses metric values into concise phrases, and uses system-level instructions at the beginning of the prompt to constrain the form, length, and content of the output. By defining such non-conventional prompting rules and by coupling them to the computed work efficiency indicators, the server reduces the number of tokens processed per inference and thereby lowers latency and computational resource consumption.

The server receives the output information from the generative AI model in the form of generated text. The server parses the generated text to extract individual instructions. For instance, the server locates line breaks or bullet markers and splits the output into instruction units. The server then normalizes each instruction unit by trimming whitespace and removing unsupported characters for the display device. The server assigns to each instruction unit a priority value, for example by analyzing its position in the generated list or by applying keyword-based rules that detect critical safety or quality-related instructions. The server determines a display time for each instruction unit based on its length and priority value. The server constructs display control data including, for each instruction unit, the instruction text, the priority, the display time, and optional metadata such as the associated step number.

The server transmits the display control data to a terminal. The terminal is, in one embodiment, a wearable computing device such as a head-mounted display or smart glasses. The terminal includes a processor, a memory, an optical display unit, input sensors such as touch, gesture, or voice input devices, and a network interface. The terminal executes client software that communicates with the server over a network using a protocol such as HTTP or a persistent connection. The terminal receives the display control data and stores it in a local memory cache.

The terminal converts the display control data into visual elements suitable for presentation in the user's field of view. The terminal calculates an appropriate placement of text overlays, font sizes, and colors based on the display capabilities of the optical unit and the priority attributes of the instruction units. The terminal displays high-priority instructions in a more conspicuous region or with a distinct visual style, while displaying lower-priority instructions in a less prominent manner. The terminal may scroll through instruction units automatically based on the display time information, or allow the user to advance manually using gestures or voice commands. By using the structured control attributes, the terminal reduces the cognitive load on the user and increases readability and safety.

The user wears the terminal and observes the displayed instructions while performing physical tasks in the real world. Using the visual guidance, the user manipulates tools, parts, or equipment, for example aligning components, tightening fasteners, or checking configurations. The user may issue feedback commands to the terminal, such as gestures indicating that a step is completed or that a recommendation has been understood. The user may also speak short commands, such as “next step” or “repeat,” which the terminal recognizes using a speech recognition module.

The terminal converts these user inputs into operation information and progress information. For example, the terminal encodes a step completion gesture as an event with a timestamp and an associated instruction identifier. The terminal encodes a voice command requesting repetition as an interaction event referencing the current instruction identifier. The terminal transmits these events to the server as progress information and operation information.

The server receives the operation information and progress information and incorporates them into the unified data. The server updates the work efficiency indicators by recalculating metrics based on the latest events, such as the time difference between when an instruction was displayed and when the corresponding step completion event was received. The server thereby measures the effect of the AI-generated instructions on actual task performance in near real time. The server may detect that a particular instruction reduces error occurrences or reduces processing time for a step, and may increase the priority of similar instructions in subsequent outputs.

The server uses the updated work efficiency indicators and interaction logs to construct a revised prompt sentence. In one example, the server constructs the following prompt sentence:
“Compare the worker's performance on step 3 before and after the following advice was given:
‘Align the notch on gear B with the mark on shaft A before tightening.’
Summarize whether the advice improved efficiency or reduced errors, and propose one more refinement suitable for smart glasses display.”

The server provides this revised prompt sentence to the generative AI model, receives a refined suggestion, and converts the refined suggestion into new display control data. As a consequence, the server closes a feedback loop between the user's behavior, the AI-generated advice, and the subsequent analysis, improving the relevance and effectiveness of future instructions. This loop operates automatically and repeatedly, enabling the system to self-adjust its outputs without manual reprogramming of rules.

Because the server uses explicitly computed work efficiency indicators, structured prompt sentences tied to those indicators, and controlled parsing and formatting of model outputs, the system improves the technical functioning of the computer as a data processing machine. The server reduces unnecessary data transfer by sending only compact display control data to the terminal instead of full analysis results. The server reduces inference cost by limiting prompt length and by reusing computed features for multiple prompt generations. The server improves data management by storing performance effects of individual instructions and using those stored effects to prioritize future instructions. These operations are not mere automation of human decision making; rather, they define a specific control architecture and data flow that enhances the computer's ability to process, filter, and route data for real-time interactive guidance.

In another embodiment, the server compares work efficiency indicators across multiple workers and constructs prompt sentences for relative pseudo evaluations. For instance, the server computes a relative work achievement degree for each worker by ranking workers by completion rate or delay degree. The server constructs a prompt sentence such as:
“Using the current progress of team members A, B, and C on task T, calculate relative pseudo evaluation values based on task completion ratio and average step duration. Generate short feedback messages for each member, indicating their relative standing and one suggestion for improvement, each under 30 words.”

The server provides this prompt sentence to the generative AI model and produces relative pseudo evaluation information. The server formats the information into display control data and sends it to the terminals of relevant users. In this embodiment, the server again uses a structured, technically constrained method of generating and applying prompt sentences in order to optimize the use of the generative AI model and the networked terminal devices.

In yet another embodiment, the generative AI model may be replaced or supplemented by other machine learning models for certain tasks. For example, the server may use a separate neural network to predict which instruction types are likely to yield the greatest performance improvement for a given worker and problem location. The server may pre-classify candidate instructions into categories, and the generative AI model may be instructed by prompt sentences to generate only instructions of selected categories. This combination of specialized models and controlled prompts further improves computational efficiency and prediction accuracy.

The described embodiments can be varied. The server may be implemented as a cluster of machines, and the generative AI model may run on a dedicated accelerator device. The terminal may be a different type of portable display apparatus, such as a handheld device with an augmented reality display. The user may be operating in different environments, such as manufacturing lines, maintenance operations, or logistics handling. In all such variations, the server, the terminal, and the user cooperate according to the same fundamental architecture: the server computes indicators and constructs prompt sentences tied to those indicators, the generative AI model generates text outputs in response, the server converts these outputs into structured display control data, the terminal presents the data in a worker's field of view, and the user's interactions and progress are fed back to the server to adjust the subsequent processing.

By defining specific data structures, prompt sentence formats, model invocation constraints, and display control attributes, the system realizes a technical improvement in how computer resources are utilized to provide real-time, context-aware guidance. The improved processing leads to reduced latency, lower communication load, more accurate targeting of recommendations, and more effective use of the generative AI model's capabilities, thereby enhancing the technical performance of the entire computing platform.

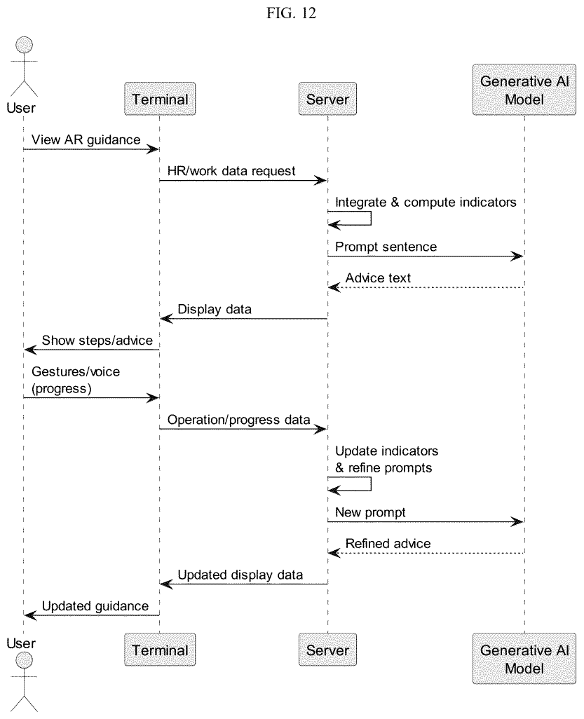

The following describes the processing flow using FIG. 12.

### Step 1:

The server acquires human resource related information from an information processing apparatus group and integrates the information into unified data.

The server receives, as input, heterogeneous data records such as performance scores, goal definitions, work logs, and error reports, transmitted from multiple external systems. The server parses these records, converts date and time fields into a standard format, maps different identifier formats into a unified worker ID and task ID space, and stores the normalized records into predefined tables in a database. The server outputs unified data entries in a relational schema, enabling subsequent computations to access all relevant information with consistent keys and formats.

### Step 2:

The server computes work efficiency indicators and identifies delay degrees and problem locations based on the unified data.

The server retrieves, as input, unified data records for each worker and each task step from the database. The server calculates, using numerical operations, metrics such as average processing time per step, variance of processing time, completion rate, and error frequency. The server compares these metrics with corresponding target values stored in the database to compute delay degrees, for example by dividing the difference between actual and target times by the target time. The server flags steps where the delay degree or error frequency exceeds a threshold as problem locations. The server outputs, for each worker-task-step combination, a feature set including work efficiency indicators and identifiers of problem locations.

### Step 3:

The server constructs a prompt sentence for a generative AI model using the work efficiency indicators and problem locations.

The server receives, as input, the feature sets that describe work efficiency indicators, delay degrees, and problem locations, along with contextual data such as task descriptions and current step numbers. The server selects relevant metrics, formats them as human-readable values, and inserts them into predefined natural language templates. For example, the server embeds average times, target times, and descriptions of frequent errors into a textual instruction that specifies constraints on the number and length of recommendations. The server outputs a prompt sentence that encodes the current work situation and desired form of the AI output.

### Step 4:

The server transmits the prompt sentence as part of input data to the generative AI model and obtains output information.

The server receives, as input, the constructed prompt sentence and optional structured context data. The server packages the prompt sentence into a request payload, applies tokenization rules, and sends the payload to the generative AI model running on an AI processing node. The generative AI model processes the tokenized input through its neural network layers and returns generated text as output. The server then decodes the token sequence back into text. The server outputs AI-generated text that contains work procedure information and improvement proposal information in natural language.

### Step 5:

The server converts the AI-generated text into structured instruction units and display control data.

The server receives, as input, the AI-generated text that may contain multiple recommendations or steps. The server splits the text into individual instruction units, for example by detecting line breaks, punctuation patterns, or numbered lists. The server removes extraneous characters, enforces maximum length constraints, and analyzes each instruction's position or keywords to assign a priority level. The server calculates an appropriate display time for each instruction, for example based on the number of characters or an estimated reading duration. The server combines the instruction text, priority, and display time into display control data structures, and outputs a list of such structures for transmission to a terminal.

### Step 6:

The server transmits the display control data to a terminal including a portable visual display apparatus.

The server receives, as input, the list of display control data structures associated with a specific worker and task context. The server encapsulates these structures in a message format suitable for network transmission and addresses the message to the terminal associated with the worker. The server sends the message over a communication network using a protocol such as HTTP or a persistent connection. The server outputs a transmitted message that contains the control parameters required by the terminal to render the instructions in the worker's field of view.

### Step 7:

The terminal receives the display control data and renders visual instructions in the worker's field of view.

The terminal receives, as input, the message containing a list of instruction units with associated priority and display time attributes. The terminal parses the message, stores the instruction units in local memory, and schedules their display according to the priority and timing parameters. The terminal generates graphical overlay elements, such as text boxes, and draws them on the optical display in positions chosen for readability and minimal obstruction of the real-world scene. The terminal outputs visual guidance to the worker by sequentially displaying the work procedure information and improvement proposal information in the portable visual display apparatus.

### Step 8:

The user performs work tasks while referring to the displayed instructions and interacts with the terminal.

The user receives, as input, the visual instructions shown in the field of view, including recommended step sequences and improvement tips. The user manipulates physical objects, such as tools and parts, in accordance with the instructions, for example by assembling components in the recommended order or checking alignments as suggested. The user performs interactions with the terminal, such as gesture inputs to confirm step completion or voice commands to request repetition of a recommendation. The user's physical actions modify the real-world work state, and the user's interactions produce implicit and explicit feedback signals for the system.

### Step 9:

The terminal captures operation information and progress information from the user and sends them to the server.

The terminal receives, as input, sensor readings and interaction events generated while the user performs tasks. The terminal interprets touch gestures, head movements, and voice commands as specific operation events, associates each event with a current instruction unit or task step, and attaches time stamps. The terminal also updates an internal progress state, such as marking the current step as completed when the user performs a designated gesture. The terminal packages these events and states as operation information and progress information, and transmits them to the server over the network. The terminal outputs messages that describe user interactions and real-time task progress in a structured format.

### Step 10:

The server updates work efficiency indicators based on the received operation information and progress information.

The server receives, as input, the messages from the terminal that include operation information and progress information. The server stores these messages into the database as new event records linked to worker and task identifiers. The server recalculates work efficiency indicators, such as actual step durations derived from the time difference between instruction display and step completion events, and updated error frequencies if error-related events are included. The server compares the newly calculated indicators with prior values to determine whether specific AI-generated instructions improved performance. The server outputs updated feature sets and performance effect measures for use in subsequent analysis.

### Step 11:

The server constructs revised prompt sentences and refines future guidance based on performance effects.

The server receives, as input, the updated feature sets and performance effect measures that indicate how previous instructions affected work efficiency. The server identifies which instructions or instruction patterns led to reduced delay degrees or error frequencies, and constructs revised prompt sentences that request refinements or new suggestions from the generative AI model. For example, the server may request confirmation of which aspects of a successful instruction should be generalized, or may ask for alternative phrasing when an instruction did not yield improvement. The server generates new prompt sentences that explicitly reference before-and-after metrics and the content of prior advice, and outputs these sentences as inputs for another round of generative AI processing.

### Step 12:

The server iterates the cycle of AI inference, display control data generation, and feedback processing to continuously optimize technical performance.

The server receives, as input, the revised prompt sentences and the most recent work efficiency indicators, and repeats the generative AI invocation and output parsing operations. The server updates display control data based on the new AI outputs and redistributes them to the terminal. Over multiple iterations, the server maintains and refines a mapping between types of problem locations and effective instruction patterns, using this mapping to bias prompt construction and instruction prioritization. The server outputs progressively optimized guidance content and an evolving internal model of instruction effectiveness, resulting in reduced computation overhead, improved accuracy of recommendations, and faster convergence to efficient work procedures from the perspective of the computing system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional personnel evaluation systems and management-support tools typically aggregate raw performance metrics, goal-attainment statuses, and work progress information into simple scores or rule-based ratings. Such systems generally rely on static thresholding, manual configuration, and ad hoc data preparation, and therefore fail to exploit structured statistical preprocessing and machine learning-based comparison among members. As a result, these systems have several technical limitations.

First, existing systems often process heterogeneous evaluation data directly in application logic without a unified preprocessing pipeline. Missing values, abnormal values, and scale differences among attributes are handled inconsistently or not at all, which leads to noisy feature spaces and reduced reliability of any downstream classification or ranking. This degrades the quality of computer-implemented analysis, causes unstable behavior of machine learning components, and increases the computational overhead for repeated manual data cleaning.

Second, even when machine learning classifiers are introduced, the construction and execution of models are typically decoupled from a prompt-driven generative model workflow. The control logic for selecting preprocessing operations, building neighbor-search-based classifiers, and computing relative pseudo-evaluations is often hard-coded. This rigid architecture impedes dynamic reconfiguration of analysis pipelines in response to new evaluation criteria, organizational structures, or data distributions, and requires specialized engineering effort whenever evaluation logic must be updated.

Third, visualization of relative positions of members within a group is frequently performed as a separate, manually defined reporting layer. Conventional systems generate charts or tables through fixed report templates that are not tied to an underlying machine learning-based notion of relative pseudo-evaluation. Because of this, the visualization does not fully reflect nuanced distance relationships in a learned feature space, and cannot easily be adapted to different comparison units or time-varying evaluation contexts without substantial code modification.

Fourth, prompt-based use of generative models in this domain is usually limited to generating natural-language summaries, without enabling the generative model to participate in orchestrating concrete data-processing procedures at the server side. In such architectures, the generative model does not output machine-readable processing procedures or executable programs for configuring preprocessing, learning-model construction, and score computation. Therefore, the server cannot automatically reconfigure or optimize its evaluation pipeline based on high-level instructions, leading to inefficient use of computational resources and reduced scalability.

Accordingly, there is a need for an improved computer-implemented evaluation system that (i) standardizes preprocessing of evaluation information using statistical imputation, outlier handling, and normalization; (ii) integrates a neighbor-search-based classification model for computing relative pseudo-evaluations and relative indices in a consistent feature space; (iii) automatically produces machine-readable instructions or executable code for the evaluation pipeline in response to prompt sentences interpreted by a generative model; and (iv) generates visualization-ready evaluation result information that directly reflects the learned relative relationships among members. Such a system should technically improve the way a processor handles evaluation data, constructs learning models, and coordinates with a generative model, thereby enhancing accuracy, flexibility, and automation of computer-based personnel evaluation processing.

The specific processing by the specific processing unit 290 of the data processing device 12 in Example 2 is realized by the following means.

The present invention provides a server comprising a processor and at least one memory storing instructions which, when executed by the processor, cause the processor to cooperate with multiple functional information processing apparatuses including a human resources information processing apparatus, a business performance information processing apparatus, a goal management information processing apparatus, a work progress information processing apparatus, and a machine learning information processing apparatus to acquire evaluation information, goal information, and work progress information of members, and to determine an analysis target based on the evaluation information; to acquire, from an information storage apparatus, evaluation information regarding the members, and to execute, using data analysis software running on a general-purpose program execution environment, a standardized preprocessing pipeline including completion of missing values, removal of abnormal values, and normalization processing based on statistical indicators so as to generate preprocessed evaluation information in a machine-learning-ready feature space; to use the preprocessed evaluation information as feature data to construct, in a machine learning framework, a learning model that performs neighbor-search-based classification processing, and to calculate, by applying the learning model, a relative pseudo-evaluation for each member together with a relative index by comparing an evaluation index of each member with a group average derived from group statistical values; to convert the calculated relative pseudo-evaluation and the relative index into graph display data and to generate evaluation result display information configured for direct visualization on a user terminal such that relative positions among the members in the learned feature space are machine-generated and visually understandable; to generate, based on information acquired from the functional information processing apparatuses and based on the relative pseudo-evaluation, a structured prompt sentence that instructs a generative information processing model to output processing procedure information or an executable program for calculating the relative pseudo-evaluation, generating an explanation thereof, and generating the evaluation result display information; and to receive, from the generative information processing model, the processing procedure information or the executable program responsive to the prompt sentence and, in accordance therewith, automatically execute the preprocessing, the construction of the learning model, the calculation of the relative pseudo-evaluation, and the generation of the evaluation result display information, and provide resulting evaluation data and visualization data to a user terminal. This enables a technical improvement in computer-based evaluation processing by unifying statistical data preprocessing and neighbor-search-based classification within an orchestrated, prompt-driven pipeline, by allowing a generative model to dynamically specify machine-executable evaluation workflows, and by automatically generating visualization-ready outputs that reflect relative relationships of members in a learned feature space, thereby enhancing the accuracy, adaptability, and automation of personnel evaluation operations performed by the server.

The term “processor” refers to a hardware computation unit, or a combination of hardware computation units, configured to execute instructions, perform arithmetic and logical operations, and control data processing within the system.

The term “memory” refers to a non-transitory computer-readable storage medium configured to store instructions and data for access and execution by the processor.

The term “human resources information processing apparatus” refers to an information processing entity configured to manage and provide personnel-related data such as member identities, positions, affiliations, and basic human resources records.

The term “business performance information processing apparatus” refers to an information processing entity configured to manage and provide data indicating business outcomes of members, including performance metrics such as sales, productivity, or achievement scores.

The term “goal management information processing apparatus” refers to an information processing entity configured to manage and provide data relating to goals, targets, and key performance indicators assigned to or set by members.

The term “work progress information processing apparatus” refers to an information processing entity configured to manage and provide data indicating the progress status of tasks, projects, or workflows performed by members.

The term “machine learning information processing apparatus” refers to an information processing entity configured to manage and provide functions for training, storing, and executing machine learning models, including models used for classification, regression, or clustering.

The term “information storage apparatus” refers to a storage subsystem or database system configured to store structured or unstructured evaluation information and other related data, and to respond to queries issued by the processor.

The term “evaluation information” refers to data representing quantitative or qualitative assessments of members, including performance scores, ability scores, or other metrics used to evaluate member activities.

The term “goal information” refers to data representing goals, targets, or desired outcomes associated with members, including their definitions, deadlines, and levels of attainment.

The term “work progress information” refers to data representing current or historical states of progress of tasks, projects, or operations being performed by members.

The term “preprocessing” refers to a series of data transformation operations applied to raw evaluation information in order to prepare the data for machine learning or statistical analysis, including completion of missing values, removal of abnormal values, and normalization.

The term “completion of missing values” refers to a process of detecting absent or undefined data entries in evaluation information and replacing such entries with substitute values derived from statistical measures or other rules.

The term “removal of abnormal values” refers to a process of detecting data entries that deviate from expected ranges or distributions and excluding or adjusting such entries to reduce the influence of outliers.

The term “normalization processing based on statistical indicators” refers to a process of transforming raw numerical data into a standardized scale, such as zero mean and unit variance, using statistics such as means and standard deviations.

The term “data analysis software” refers to a software framework or library configured to perform data manipulation, statistical computation, and machine learning operations within a general-purpose program execution environment.

The term “general-purpose program execution environment” refers to a software runtime environment capable of executing a broad range of application programs, scripts, and libraries, including data analysis and machine learning components.

The term “preprocessed evaluation information” refers to evaluation information that has been subjected to one or more preprocessing operations, thereby being converted into a feature representation suitable for input to a machine learning model.

The term “feature data” refers to numerical or categorical representations of attributes derived from evaluation information and used as inputs to machine learning algorithms.

The term “learning model” refers to a machine learning construct, including its structure and parameters, that has been trained using feature data and labels to perform tasks such as classification or prediction.

The term “neighbor-search-based classification processing” refers to a classification technique that determines a class for a target sample by examining the similarity or distance to neighboring samples in a feature space, such as in a k-nearest-neighbor approach.

The term “relative pseudo-evaluation” refers to an evaluation value that indicates the relative position of a member with respect to other members, computed in a feature space using a learning model rather than solely from direct raw scores.

The term “relative index” refers to a quantitative measure representing how a member's evaluation compares to a group reference, such as a group average or percentile, derived from group statistical values.

The term “group statistical values” refers to aggregated numerical measures, such as means, variances, or percentiles, computed over evaluation information for a defined set of members in a group or division.

The term “graph display data” refers to structured data representing visual elements of a graph, including coordinates, labels, and styling information, suitable for rendering on a display apparatus.

The term “evaluation result display information” refers to information derived from evaluation computations and formatted into a representation that can be displayed visually, such as charts, tables, or other graphical forms indicating relative positions of members.

The term “display apparatus” refers to an output device, including but not limited to a monitor, screen, or panel, configured to visually present information to a user.

The term “prompt sentence” refers to a structured natural-language or semi-structured instruction provided to a generative information processing model, specifying desired analysis, prediction, or generation tasks.

The term “generative information processing model” refers to a model configured to generate outputs such as text, code, or structured instructions in response to input prompts, including models that learn probabilistic relationships from training data.

The term “processing procedure information” refers to machine-readable instructions or specifications describing a sequence of data processing, preprocessing, and model-execution steps that can be carried out by the processor.

The term “executable program” refers to a set of machine-executable or interpretable instructions generated or provided to implement specific data processing and evaluation operations on the server.

The term “user terminal” refers to a client-side computing device, such as a personal computer, tablet, or mobile terminal, configured to communicate with the server and to present evaluation result display information to a user.

The term “division” refers to an organizational unit or subgroup of members defined within an organization for management, evaluation, or reporting purposes.

The term “group” refers to a collection of members treated as a unit for the purposes of computing group statistical values, relative indices, and relative pseudo-evaluations.

The term “distance information” refers to quantitative measures of similarity or dissimilarity between members in a feature space, typically expressed as distances computed by a neighbor-search-based algorithm.

The term “rank information” refers to information indicating an ordering of members based on one or more evaluation metrics, such as relative pseudo-evaluations or relative indices.

The term “ranking information” refers to a structured representation of rank positions of members, including their order and associated scores or indices, suitable for display or further processing.

The term “visualization information” refers to data formatted for graphical representation, such as coordinates, labels, colors, and shapes, used to depict evaluation results and relative relationships among members.

The term “time interval” refers to a predefined or dynamically determined period between successive executions of processing tasks, such as repeated generation of prompt sentences or recalculation of relative pseudo-evaluations.

The term “event occurrence” refers to a defined trigger condition, such as an update of evaluation information, completion of a reporting period, or receipt of a user request, that causes the processor to initiate specific processing steps.

The term “temporal change” refers to variation in evaluation values, relative pseudo-evaluations, or relative indices over time, derived from evaluation data captured at multiple time points.

The term “manager” refers to a user who has responsibility for supervising, evaluating, or managing the growth and performance of members and who consumes evaluation result display information for management decisions.

In one embodiment, a server implements a personnel evaluation support system using a processor and a memory that stores instructions. The server operates in cooperation with one or more terminals operated by users such as managers or members. The server executes a plurality of software components including, for example, a relational database management system, a data analysis environment implemented in a programming language runtime (such as a Python runtime), a machine learning library (such as a general-purpose numerical computation and machine learning library), and a generative AI model executed on a model-serving platform. The terminal executes a web browser or a native application and includes a display apparatus for visually presenting evaluation results, including relative pseudo-evaluation values.

The server uses a human resources information processing module, a business performance information processing module, a goal management information processing module, a work progress information processing module, and a machine learning information processing module as functional units implemented in software. Each functional unit may be implemented as a set of processes, microservices, or application modules. The server stores evaluation information, goal information, and work progress information in one or more databases, such as a relational database that stores tabular records keyed by member identifiers. The server uses a database driver library to access the database via a communication interface, and to retrieve and update records that represent evaluation information.

The server uses a data analysis environment, for example a runtime capable of executing data analysis libraries such as a table-processing library and a scientific computing library. The server loads raw evaluation data into an in-memory table structure, where each row represents a member and each column represents an attribute, such as performance score, ability score, goal-attainment ratio, or progress percentage. The server uses typed columns (for example, floating-point types for scores and categorical types for departments) so that subsequent machine learning components operate on well-defined data types. The server performs type conversion, column reordering, and indexing based on member identifiers in order to maintain consistent data structures and to reduce lookup time when integrating data from multiple modules.

The server performs preprocessing on the evaluation information using the data analysis environment. The server detects missing values by scanning each column for null entries and constructs a mask array to mark such entries. The server computes aggregate statistics such as mean, median, and standard deviation for numerical columns. The server fills missing entries with replacement values derived from statistics of each column (for example, column mean). This replacement is performed in a vectorized manner over the in-memory table, which reduces the number of memory accesses and CPU instructions compared to row-by-row handling. The server aggregates information about replaced entries in a log record, storing counts and replacement statistics. This log is stored in a log storage system so that subsequent executions can reuse derived statistics and detect drift in the distribution of data.

The server detects abnormal values using a three-sigma-based method or a quantile-based method. For each numerical column, the server calculates a mean and a standard deviation, and defines an acceptable range. The server then constructs a boolean mask indicating whether each row falls within the acceptable range for each numerical attribute. The server creates a filtered dataset by excluding rows that violate range conditions for one or more attributes. In another variation, the server clamps abnormal values to the boundary values of the acceptable range instead of discarding rows. The server records information about removed or clamped values, which can be used for later analysis of data quality. By executing these outlier-processing operations in memory using vectorized array operations, the server reduces CPU cache misses and thus improves processing throughput compared to naive row-iteration methods.

The server normalizes numerical attributes using a statistical normalization method implemented in a machine learning preprocessing library, such as a standardization transformer that computes per-feature means and variances and transforms each value to a standardized score. The server first creates a two-dimensional numerical matrix that contains selected features, for example performance scores and ability scores. The server calls a fit operation on the standardization transformer to compute scaling parameters, and then calls a transform operation that converts each feature vector into a normalized feature vector. The server stores the scaling parameters in a model storage area on a non-transitory storage medium so that future data can be transformed consistently. This normalization aligns the magnitude of different feature dimensions and has a direct technical effect: distance computations in the subsequent neighbor-search-based classification model become numerically stable, and the impact of scale differences between attributes is reduced, thereby improving classification accuracy and convergence properties.

The server uses the preprocessed and normalized feature matrix to construct a neighbor-search-based classification model. In one embodiment, the server uses a k-nearest neighbor classifier. The server selects a number of neighbors k, a distance metric such as Euclidean distance or Mahalanobis distance, and a weighting scheme (for instance, uniform weighting or distance-based weighting). The server invokes a fit operation on the classifier, which stores training feature vectors and associated class labels in an internal data structure. The internal data structure may be a k-d tree, a ball tree, or a brute-force array, depending on configuration. When the classifier is configured to use a k-d tree, the server constructs a balanced tree over normalized feature vectors in order to accelerate neighbor searches by reducing the number of distance computations during query operations. The k-d tree structure improves query time complexity for nearest-neighbor searches compared to naive linear scans, leading to faster computation of relative pseudo-evaluations when the number of members is large.

The server assigns class labels to members based on relative rating categories. The server may compute a global performance index for each member by combining multiple attributes, such as performance score and ability score, into a single scalar via a linear combination with pre-defined weights, or via a learned transformation. The server then partitions the distribution of this index into ranges corresponding to “high”, “medium”, and “low” categories or into percentile-based bands. The server stores these labels alongside the feature matrix. During prediction, the classifier outputs the most frequent label among the nearest neighbors for a target member. The server interprets this label as a relative pseudo-evaluation category.

The server also calculates a relative index value for each member. The server computes group statistics for a target group, such as a division or team, by aggregating normalized feature values across all members in the group. The server calculates the group average and variance, as well as percentiles for the chosen index. The server then computes, for a given member, a relative index such as “10 percent above group average” or “80th percentile in group”. This computation uses vector operations on the normalized feature matrix and aggregated statistics, allowing the server to generate relative indices efficiently without recomputing aggregates for each member individually.

The server transforms relative pseudo-evaluations and relative indices into graph display data. The server uses a visualization library on the server side to construct a representation of charts, including bar charts, line graphs, or radar charts. The server defines axis labels, tick positions, color palettes, and legend entries using structured objects. The server then either renders the visualization into an image format such as PNG or prepares a structured graph specification (for example, a JSON-like object of graphical primitives) that a terminal-side renderer can use. The server compresses the image or graph specification before transmission, which reduces bandwidth usage and improves response time for terminals accessing the system over constrained networks.

The server includes a generative AI model, such as a large language model or a sequence-to-sequence model, which is used not only to produce natural-language responses but also to generate processing procedure information or executable code segments. The generative AI model may be implemented as a neural network with multiple layers, including an embedding layer, multiple transformer blocks, and an output projection layer. The server hosts this generative AI model in a containerized environment or accesses it via an external model-serving interface.

The server prepares prompt sentences as input to the generative AI model. The server constructs prompt sentences dynamically based on the current state of evaluation data and the analysis requirements. Examples of prompt sentences include:
“Using Employee A's performance and ability evaluation data in the sales division, compute a relative pseudo-evaluation compared to other division members and generate a bar chart showing the difference from the division average.”
“From the evaluation information of all members in the organization, standardize the feature values, construct a k-nearest neighbor classifier, and output the processing steps required to compute a relative pseudo-evaluation for each member.”
“Based on the latest quarterly performance scores and goal attainment data, generate a procedure to recalculate relative pseudo-evaluations for all members and update the visualization to show changes over the last four quarters.”

The server inputs these prompt sentences as plain text to the generative AI model. The generative AI model tokenizes the text, passes token sequences through its transformer layers, and predicts output token sequences representing processing procedure information or code fragments. The server converts output tokens into text and parses this text to extract structured information, for example a description of preprocessing steps, feature selection, model parameters, and visualization types. The server validates the extracted processing procedure information using rule-based checks to avoid unsafe operations and to ensure that required modules and data structures exist.

The server executes validated processing procedures in a controlled environment, such as a sandbox or a limited-permission container. The server thereby performs automatic configuration and reconfiguration of its preprocessing pipeline, model training pipeline, and visualization pipeline. This use of a generative AI model is not a mere automation of human reasoning; rather, it directly affects how the server arranges internal data structures, how it chooses machine learning algorithms and parameters, and how it orders computations to reduce redundant passes over data. For instance, the generative AI model can propose that normalization and outlier handling be fused into a single pass over the dataset instead of two separate passes, thereby reducing memory bandwidth usage and improving cache efficiency. By adopting such non-conventional, generated procedures, the server achieves measurable improvements in processing speed and resource utilization compared to static pipelines.

The server also uses the generative AI model to generate explanation text for relative pseudo-evaluations. The server includes in the prompt not only the member's scores and relative indices but also derived statistics such as distances to nearest neighbors and category boundaries. The generative AI model produces natural-language descriptions that reference these statistics, such as “Employee A is classified as a high performer because the normalized performance score is higher than 90 percent of peers and the nearest neighbors are primarily in the high category.” The server stores the explanation text alongside the numerical results and transmits both to the terminal. The user can thereby understand not only the numerical relative pseudo-evaluation but also the reasons that follow from the machine learning model's distance-based classification.

The server constructs the internal architecture as a set of modules interconnected by message queues or function calls. A data ingestion module retrieves evaluation data from the database. A preprocessing module executes missing-value completion, outlier removal, and normalization. A model management module trains and stores machine learning models, including the neighbor-search-based classifier. An evaluation computation module computes relative pseudo-evaluations and relative indices. A visualization module creates graph display data. A prompt generation module constructs prompt sentences for the generative AI model. A generative integration module parses and executes processing procedure information output by the generative AI model. This modular design allows the server to scale out specific modules, for instance by deploying multiple instances of the preprocessing module to accommodate large batches of evaluation data. This improves throughput and reduces latency for generating updated evaluation results.

In another embodiment, the server uses different types of neighbor-search-based models, such as approximate nearest neighbor indices constructed with specialized libraries. The server may precompute index structures on normalized feature vectors and store them in memory for rapid query-time lookup. This approach further reduces latency when computing relative pseudo-evaluations in response to real-time requests from terminals. The server may also integrate alternative learning models, such as a feed-forward neural network that maps normalized features to a continuous relative score, and then applies quantile thresholds to obtain discrete relative pseudo-evaluation categories. The feed-forward neural network may include several fully connected layers with nonlinear activation functions, and be trained using backpropagation with a loss function such as mean squared error or cross-entropy, depending on whether the output is a regression or classification target.

The server trains such a neural network with historical evaluation data, where labels are derived from known performance outcomes or expert assessments. During training, the server uses mini-batch optimization, updates weights based on gradients computed from the loss function, and applies regularization techniques such as dropout or weight decay to avoid overfitting. The server stores trained model parameters in the machine learning information processing module. During inference, the server computes a relative score for a member in a single forward pass through the network, which is implemented as matrix multiplications and activation function evaluations. Because the network operates on normalized features, its outputs remain stable even when the absolute scale of original evaluation data changes.

The server uses these models in combination with the generative AI model. For example, the server may instruct the generative AI model to generate a prompt that specifies whether to use the k-nearest neighbor model or the neural network model depending on data volume, required response time, and model accuracy metrics. The generative AI model then returns a recommended configuration, including hyperparameters, which the server applies to switch models or adjust threshold values. This dynamic selection and tuning process is a non-conventional use of a generative AI model that results in practical improvements in computational efficiency and prediction accuracy for the evaluation system.

The terminal receives evaluation result display information from the server via a network interface. The terminal parses structured visualization data or downloads chart images, and renders them on a display apparatus. The terminal may allow the user to interact with the visualization, for example by selecting different divisions or time periods. When the user selects a new subset, the terminal sends a request to the server, which triggers the server to recompute or retrieve corresponding relative pseudo-evaluations and visualization data. By distributing computationally intensive tasks to the server and limiting the terminal's role to display and lightweight interaction, the system reduces computational load on the terminal and enables consistent performance across different client hardware.

The user operates the terminal to view, compare, and interpret evaluation results. The user can request detailed explanations generated by the generative AI model, can select different comparison groups, and can monitor changes in relative pseudo-evaluations over time. The user does not need to manually manipulate raw data or configure complex analysis pipelines; instead, the user interacts with high-level controls on the terminal, while the server executes a technically sophisticated data-processing and model-execution workflow as described above.

In summary, the server implements a concrete and structured data-processing pipeline that includes statistical preprocessing, feature normalization, neighbor-search-based classification, relative index computation, and visualization data generation. The server further integrates a generative AI model not as a black-box decision maker, but as a component that generates machine-readable processing procedure information used to configure and improve the internal pipeline. This arrangement yields direct technical effects in the computer system: reduced processing time through optimized data passes and index structures, improved classification accuracy through standardized feature scaling and distance metrics, reduced network load through compressed and structured visualization data, and improved data management through consistent logging and reuse of preprocessing parameters. The cooperation of the server, the terminal, and the generative AI model, as described above, allows the invention to be implemented in a manner that is reproducible, scalable, and technically advantageous beyond mere automation of human mental processes.

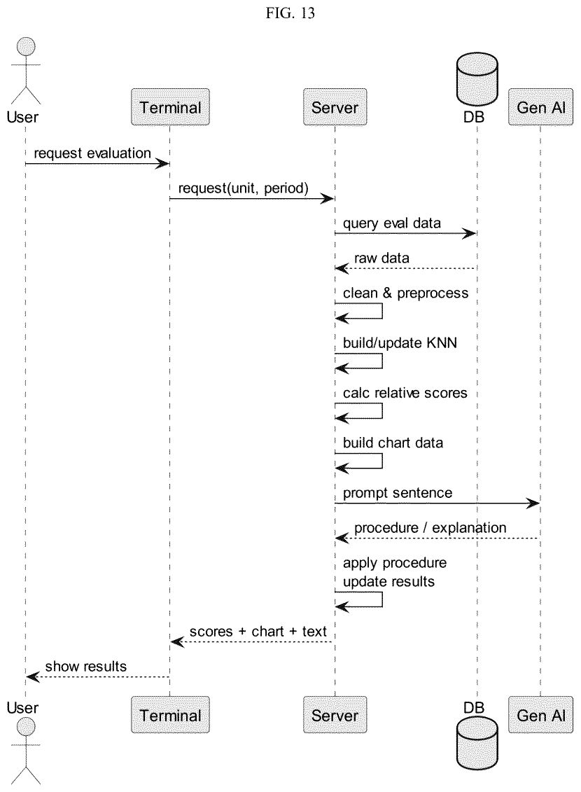

The following describes the processing flow using FIG. 13.

### Step 1:

The server acquires raw evaluation information from a data storage apparatus.

The server receives, as input, a request from a terminal specifying at least a target organization unit (for example, a division) and a target period. The server uses this input to construct one or more database queries that target tables storing member identifiers, performance scores, ability scores, goal-attainment rates, and work progress metrics. The server sends the queries to a relational database management system and receives, as output, one or more result sets in tabular form. The server loads these result sets into in-memory table structures, aligns them by member identifier, and generates a unified raw evaluation dataset that includes all requested attributes for each member.

### Step 2:

The server performs type checking and basic normalization of the raw evaluation dataset.

The server receives, as input, the unified raw evaluation dataset from Step 1. The server inspects each column to determine its data type (for example, numeric, categorical, or temporal) and converts inconsistent formats (such as string-encoded numbers) into proper numeric or categorical types. The server detects duplicate member records, merges them or removes duplicates based on predefined rules, and ensures that each member has a unique key. The server outputs a cleaned, type-consistent dataset in which each row corresponds to one member and each column corresponds to one typed attribute, serving as a basis for further statistical preprocessing.

### Step 3:

The server executes completion of missing values in the evaluation dataset.

The server receives, as input, the type-consistent dataset from Step 2. The server scans each numerical column to identify missing entries and builds masks that mark the positions of missing values. The server computes statistical aggregates, such as mean or median, for each numerical column, excluding missing entries from calculations. The server replaces each missing numerical entry with a corresponding aggregate value derived from that column, thereby filling gaps in the dataset. The server outputs an updated dataset in which missing numerical values have been replaced with statistically derived surrogates, improving the completeness of the data for subsequent machine learning.

### Step 4:

The server detects and processes abnormal values in the evaluation dataset.

The server receives, as input, the dataset with completed missing values from Step 3. For each numerical attribute, the server computes the mean and standard deviation and defines an acceptable range using a three-sigma rule or a predetermined threshold. The server then evaluates each row to determine whether the value of each attribute lies within the acceptable range. For rows with out-of-range values, the server either removes the rows from the dataset or clamps the out-of-range values to the nearest boundary value of the range, depending on a configuration parameter. The server outputs a filtered and optionally clamped dataset in which abnormal values are mitigated, thereby reducing the influence of extreme outliers on downstream classification.

### Step 5:

The server normalizes numerical attributes to produce standardized feature data.

The server receives, as input, the outlier-processed dataset from Step 4. The server extracts selected numerical attributes, such as performance scores and ability scores, and arranges them into a feature matrix. The server computes, for each feature column, a mean and standard deviation and applies a standardization formula that subtracts the mean and divides by the standard deviation, thereby transforming each original value into a standardized value. The server writes the standardized values back into a new feature matrix and stores the computed means and standard deviations as normalization parameters. The server outputs a normalized feature matrix and a set of normalization parameters, ensuring that all targeted features are on a comparable scale.

### Step 6:

The server constructs a neighbor-search-based classification model using the normalized feature data.

The server receives, as input, the normalized feature matrix and associated member identifiers from Step 5, as well as classification labels derived from historical performance outcomes or preconfigured thresholds. The server stores the feature matrix and labels in an internal model-training structure. The server constructs an index structure, such as a k-dimensional tree or another nearest-neighbor index, over the feature vectors to support efficient neighbor searches. The server then binds the feature matrix, index structure, and labels into a classification model object configured to perform k-nearest neighbor classification. The server outputs a trained neighbor-search-based classification model that can assign relative pseudo-evaluation labels to new or existing members based on their feature vectors.

### Step 7:

The server computes relative pseudo-evaluations and relative indices for members.

The server receives, as input, the normalized feature matrix from Step 5 and the neighbor-search-based classification model from Step 6. For each target member, the server retrieves the corresponding normalized feature vector and queries the model for its k nearest neighbors, obtaining indices and distances. The server determines the member's pseudo-evaluation category from the majority label (or weighted majority label) among the neighbors. The server also aggregates feature values across all members in a specified group to compute group statistics such as average scores and percentiles. Using these group statistics, the server computes relative indices for each member, for example the percentage by which a member's score exceeds the group average. The server outputs a dataset that associates each member with a relative pseudo-evaluation category, neighbor distance information, and one or more relative indices.

### Step 8:

The server generates graph display data for visualizing relative pseudo-evaluations.

The server receives, as input, the dataset of relative pseudo-evaluations and relative indices from Step 7, along with visualization parameters, such as chart type, target group, and selected members. The server constructs a graph data structure that specifies axes, labels, data series, and styling attributes for a chart. For example, the server composes a bar chart specification where one bar represents the group average and another bar represents a selected member's relative index. The server may produce additional data series to show rank positions or distribution histograms. The server then converts this specification into either an image (for example, a PNG file) or structured visualization data suitable for client-side rendering. The server outputs graph display data that can be directly rendered by the terminal to depict relative positions among members.

### Step 9:

The server generates a prompt sentence for a generative AI model based on the evaluation context.

The server receives, as input, the latest relative pseudo-evaluation data, group statistics, model configuration parameters, and user preferences or system policies (for example, whether to update the model or recalculate indices). The server composes a prompt sentence in natural language that specifies desired operations and context. The server may include in the prompt: a description of the available features, the type of model in use (for example, k-nearest neighbor classifier), target members or groups, and required outputs such as updated relative pseudo-evaluations or explanatory text. Example prompt sentences generated by the server include:
“Using Employee A's normalized performance and ability scores, and the current k-nearest neighbor classifier for the sales division, compute the relative pseudo-evaluation and generate a bar chart comparing Employee A with the division average.”
“From the organization-wide evaluation dataset, define a standardized preprocessing pipeline, construct a neighbor-search-based classifier, and output the ordered steps needed to recompute relative pseudo-evaluations for all members.”

The server outputs the constructed prompt sentence as text, ready to be transmitted to the generative AI model.

### Step 10:

The server obtains processing procedure information from the generative AI model.

The server receives, as input, the prompt sentence generated in Step 9. The server transmits the prompt sentence to a generative AI model endpoint over a network interface. The generative AI model processes the prompt and outputs a text response describing processing steps, configurations, or code-like instructions to be executed by the server. The server receives this text and parses it to extract structured processing procedure information, such as which preprocessing operations to apply, which features to select, which model parameters (for example, number of neighbors k, distance metric) to use, and what visualization types to generate. The server discards unsupported or unsafe instructions and retains only those consistent with its internal policy and interface specifications. The server outputs validated processing procedure information that can be applied to configure or adjust its evaluation pipeline.

### Step 11:

The server reconfigures and executes the evaluation pipeline according to the processing procedure information.

The server receives, as input, the validated processing procedure information from Step 10 and current evaluation data from previous steps. The server maps the described operations to internal modules, for example by enabling or disabling certain preprocessing steps, adjusting model hyperparameters, or changing visualization configurations. The server then executes the indicated sequence of operations, which may include rerunning missing-value completion with different strategies, recomputing outlier thresholds, retraining the neighbor-search-based model, recalculating relative pseudo-evaluations, and regenerating graphs. As it performs these computations, the server uses the data structures and algorithms specified in earlier steps, but parameterized according to the generative AI model's instructions. The server outputs updated relative pseudo-evaluations, indices, and visualization data that reflect the reconfigured pipeline.

### Step 12:

The server transmits evaluation results and visualization data to the terminal.

The server receives, as input, the finalized evaluation results and associated graph display data from Step 8 or Step 11, together with identifiers of target users or groups that requested the analysis. The server packages these outputs into a response message, typically in a structured format including numerical values, relative categories, explanatory text, and visualization data or references to visualization resources. The server sends this response message over a communication network to the terminal. The terminal receives the response, parses the structured content, and renders the graphs and explanations on a display apparatus such that the user can view the relative positions of members and interpret the underlying reasons. The terminal outputs a visual representation of evaluation results, while the server completes the end-to-end processing cycle by having transformed raw evaluation data into refined, visually interpretable, and dynamically configurable relative pseudo-evaluations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In large-scale organizations and production environments, operational and personnel-related data are typically scattered across heterogeneous subsystems, such as personnel information management systems, performance evaluation systems, target management systems, progress monitoring systems, and equipment monitoring systems. These subsystems often store data in isolated databases and expose only limited, static reports. As a result, it is difficult for computing systems to automatically derive integrated performance indicators, to detect performance degradation or delays in near real time, or to generate context-aware recommendations without extensive manual configuration.

Conventional analytics platforms generally require human experts to design fixed rule sets, dashboards, and static queries. These platforms are not designed to dynamically construct machine-understandable instructions for advanced models, such as generative models for natural language, based on live operational data. Consequently, known systems are unable to automatically convert raw time-series data and multi-dimensional performance indicators into adaptive prompt sentences that drive higher-level comparative analysis and recommendation generation. This leads to inefficiencies in processing pipelines, such as repeated manual feature selection, ad-hoc query formulation, and separate post-processing of results.

Further, even when a generative model is integrated, conventional systems typically treat the model as an isolated component: the model is invoked with manually written prompts, the output is displayed as unstructured text, and there is no closed-loop mechanism that converts the model's natural-language output back into structured metrics, refreshed visualizations, and control logic. As a result, the generative model does not effectively improve the core behavior of the computing system itself, such as when and how to recompute rankings, when to escalate performance anomalies, or how to adapt dashboards to the evolving context.

Another problem is that known monitoring systems focus either on human performance metrics or on machine performance metrics, but not both in a unified computational framework. This separation prevents the processor from leveraging correlations between personnel-related data (for example, targets, progress, and team composition) and apparatus-related data (for example, production efficiency, operation indices, and relative rankings). Without such integration, the system cannot automatically generate granular advice that coordinates personnel allocation, apparatus operation, and task prioritization based on a unified analysis.

Accordingly, there is a need for a computer-implemented system and server-side processing architecture that (i) programmatically aggregates multi-source time-series data from personnel subsystems and apparatus subsystems, (ii) computes standardized efficiency and relative performance indices, (iii) automatically constructs data-dependent prompt sentences for a generative AI model, (iv) parses and structures the generative model's natural-language output into machine-usable advice and pseudo-evaluations, and (v) drives an interactive visualization and feedback loop that continuously adapts to new data and detected conditions. By tightly integrating these steps within the processor, the invention aims to improve the way the computer itself orchestrates data processing, model invocation, and user interaction, resulting in enhanced computational efficiency, scalability, and decision support quality.

The specific processing by the specific processing unit 290 of the data processing device 12 in Application Example 2 is realized by the following means.

The present invention provides a server comprising a processor and one or more memory devices storing instructions, the instructions causing the processor to integrate personnel information, evaluation information, target information, and progress information acquired from plural information processing apparatuses with operation information acquired from detection apparatuses associated with production apparatuses, to store the integrated information as normalized time-series data, and to aggregate the time-series data by unit time and by apparatus unit; to execute numerical operations on the aggregated operation information in order to calculate, for each apparatus or organizational unit, production efficiency information and operation index information, to compute relative performance information by comparing the production efficiency information and the operation index information among multiple apparatuses or units, and to generate rank information and low-performance apparatus identification information based on the relative performance information; to generate, automatically and without human intervention, a prompt sentence for a generative AI model, the prompt sentence including at least part of the personnel information, evaluation information, target information, progress information, production efficiency information, operation index information, relative performance information, and low-performance apparatus identification information as input conditions, and to cause the generative AI model to execute comparison analysis processing or prediction processing based on the prompt sentence; to parse natural-language output returned from the generative AI model, to extract improvement measure information, personnel allocation adjustment information, work priority adjustment information, and pseudo-evaluation information therefrom, and to convert at least part of the extracted information into structured numerical and categorical data; to structure the production efficiency information, the relative performance information, and the structured information extracted from the generative AI model as visualization data; to generate, based on the visualization data, list display information and detailed display information including updated performance metrics and model-derived advice, and to transmit the list display information and the detailed display information to a terminal apparatus for interactive display; and to monitor the production efficiency information, the relative performance information, and the progress information against predetermined performance-degradation conditions or delay conditions, to automatically generate additional prompt sentences including condition content and related apparatus or personnel context when a condition is satisfied, and to re-invoke the generative AI model to obtain updated analysis or proposals, thereby closing a feedback loop in which subsequent time-series data aggregation, ranking computation, and visualization are adaptively controlled based on prior model outputs. This enables the computing system to autonomously orchestrate multi-source data integration, metric computation, generative AI invocation, and interactive visualization in a tightly coupled feedback loop, thereby improving the efficiency, adaptability, and quality of computer-implemented monitoring, evaluation, and recommendation processes beyond what is achievable with conventional static analytics and manually formulated prompts.

The term “personnel information” refers to information representing attributes, roles, assignments, or identifiers of individuals in an organization, including at least one of identifiers, organizational affiliation, job categories, or responsibility information, and used by the system for analysis and control.

The term “evaluation information” refers to information representing assessment results of performance or outcomes for individuals, organizational units, or apparatuses, including at least one of scores, ratings, rankings, or qualitative assessments.

The term “target information” refers to information representing goals, thresholds, or expected values for performance or progress, including at least one of numerical targets, deadlines, or qualitative objectives associated with individuals, organizational units, or apparatuses.

The term “progress information” refers to information representing a current state of advancement toward a target, including at least one of completion percentages, milestone states, elapsed times, remaining workloads, or status flags.

The term “learning information processing apparatus” refers to an information processing apparatus configured to perform machine-learning or statistical-learning operations on input data to derive models, patterns, or parameters used by other components of the system.

The term “operation information” refers to information representing operating states or behaviors of a production apparatus, including at least one of on/off state, runtime, idle time, production quantity, error occurrences, or alarm states.

The term “detection apparatus” refers to a sensing or monitoring device associated with a production apparatus, configured to detect physical or logical conditions of the production apparatus and to output operation information as digital signals or data records.

The term “production apparatus” refers to an equipment unit, machine, or automated device configured to perform a production-related operation, such as assembling, processing, transporting, or inspecting workpieces or materials.

The term “time-series data” refers to data records that are associated with time information, such as timestamps or time intervals, and that are stored or processed in chronological order or by aggregation over time units.

The term “aggregation by unit time and by apparatus unit” refers to processing that groups time-series data according to predetermined time intervals and identifiers of apparatuses or units, and that computes summary values such as sums, averages, or counts for each group.

The term “production efficiency information” refers to information obtained by numerical operations on operation information, representing efficiency of a production apparatus or unit, including at least one of output per unit time, utilization ratio, throughput, or approximated overall effectiveness.

The term “operation index information” refers to information representing one or more indices derived from operation information, including at least one of uptime ratios, downtime ratios, error frequencies, cycle times, or other quantitative measures of operation characteristics.

The term “relative performance information” refers to information representing a comparative relationship among plural apparatuses or units, obtained by comparing production efficiency information and operation index information across the plural apparatuses or units.

The term “rank information” refers to information indicating an order or hierarchy among apparatuses or units, determined based on relative performance information, and including at least one of rank positions, ordered lists, or grouped categories.

The term “low-performance apparatus identification information” refers to information indicating one or more apparatuses whose performance measures satisfy predefined low-performance criteria, including at least one of identifiers, flags, or annotations of such apparatuses.

The term “generative information processing model” refers to a computing model configured to generate natural-language or structured output based on input data and a prompt sentence, and that performs at least one of comparative analysis, prediction, or recommendation generation.

The term “prompt sentence” refers to a textual input sequence provided to a generative information processing model, the textual input sequence specifying tasks, context, or conditions for analysis or prediction, and including at least part of the information managed by the system.

The term “comparison analysis processing” refers to processing by which a model or the processor evaluates similarities, differences, or relationships among multiple entities or data sets, and outputs comparative descriptions, explanations, or metrics.

The term “prediction processing” refers to processing by which a model or the processor estimates future values, states, or outcomes based on historical or current data and, optionally, specified conditions.

The term “natural-language output” refers to output data expressed in a human language, produced by a generative information processing model, and including at least descriptions, explanations, or recommendations.

The term “improvement measure information” refers to information derived from natural-language output that describes proposed changes to configurations, operations, or allocations, aimed at improving performance or efficiency of apparatuses or organizational units.

The term “personnel allocation adjustment information” refers to information indicating recommended changes to assignments, distributions, or responsibilities of personnel across tasks, teams, or apparatuses.

The term “work priority adjustment information” refers to information indicating recommended changes to an order, scheduling, or emphasis of tasks or activities for individuals or units, based on performance or context.

The term “advice information” refers to structured information including at least improvement measure information, personnel allocation adjustment information, and work priority adjustment information, which is intended to support decision making by a user.

The term “pseudo-evaluation information” refers to evaluation-like information that is derived or inferred by computation or modeling, rather than being directly recorded as an official evaluation, and that represents relative positions or tendencies of entities.

The term “visualization data” refers to data structures prepared for generating graphical or tabular displays, including at least numerical values, categorical labels, and layout metadata associated with performance metrics and advice information.

The term “list display information” refers to visualization data formatted to display multiple entities or metrics in a list or overview format, such as tables, ranked lists, or aggregated summaries.

The term “detailed display information” refers to visualization data formatted to display detailed metrics, time-series charts, or expanded explanations for one or more selected entities or units.

The term “terminal apparatus” refers to an information processing device, such as a client computer, a portable terminal, or a communication device, configured to receive display information from the server and to accept user operations.

The term “apparatus selection operation information” refers to information representing a user operation that designates one or more apparatuses, such as selection from a list, a click, or a tap on a displayed element.

The term “period designation operation information” refers to information representing a user operation that designates a time range or time interval for which data or visualizations are to be retrieved or recalculated.

The term “performance-degradation condition” refers to one or more predefined logical conditions that are evaluated against performance-related metrics, such as thresholds for efficiency decreases, error rate increases, or ranking drops.

The term “delay condition” refers to one or more predefined logical conditions that are evaluated against progress-related metrics, such as lateness of milestones, accumulated delays, or deviations from planned schedules.

The term “organizational unit” refers to a logical unit within an organization, such as a team, department, line, or group of apparatuses, treated as a single entity for analysis and evaluation.

In one embodiment, a server implements the claimed system as a network-connected computing apparatus including at least one processor, a main memory, a non-volatile storage device, a network interface, and, in some cases, a hardware accelerator such as a graphics processing unit. The server executes an operating system, such as a general-purpose server operating system, and runs application software written, for example, in a programming language such as Python. The server communicates over a communication network with multiple terminal devices and with one or more equipment-side controllers associated with production apparatuses.

The server acquires personnel information, evaluation information, target information, and progress information from plural information processing systems, such as a personnel information processing apparatus, an evaluation information processing apparatus, a target information processing apparatus, a progress information processing apparatus, and a learning information processing apparatus. Each of these external systems exposes an application programming interface or a database connection. The server uses a database driver or an API client to retrieve records, and normalizes the retrieved data into internal data structures, for example tabular structures equivalent to data frames. The server assigns standardized field names, such as unit identifiers, timestamps, score values, and target thresholds, and stores the normalized records in a relational database or a time-series database.

The server also acquires operation information from detection apparatuses that are physically coupled to production apparatuses, such as sensors, controllers, or programmable logic controllers. The detection apparatuses output operation information including at least runtime counters, production quantity counters, state codes, and error codes. The server receives this information through field gateways or industrial communication interfaces, and persists it as time-series records in a storage structure indexed by apparatus identifiers and time.

The server integrates the personnel-related data and the apparatus-related data into normalized time-series data. The server represents the integrated data as records containing, for each relevant time interval and apparatus or organizational unit, fields such as time index, apparatus identifier, unit identifier, production quantity, runtime, error count, assigned personnel, target output, and progress ratio. The server stores these integrated records in a table or a key-value store that supports efficient aggregation by time and by apparatus. The server thereby reduces the need for multiple joins at query time, which improves query latency and reduces memory overhead when the server later computes performance metrics.

The server executes numerical operations on the integrated time-series data to derive production efficiency information and operation index information. For example, the server computes a production efficiency value by dividing a production quantity by an effective runtime in a given interval, and computes an operation index value by combining uptime ratio, error frequency, and cycle time in a weighted formula. The server selects weights according to configuration parameters stored in memory, and applies vectorized operations across a contiguous block of records. By packing contiguous time intervals for each apparatus and organizational unit, the server reduces cache misses and improves throughput relative to a purely row-by-row evaluation approach.

The server computes relative performance information by comparing the production efficiency information and the operation index information across plural apparatuses or organizational units. The server can compute, for example, the mean efficiency per apparatus over a sliding window, the median efficiency across all apparatuses, and a deviation score obtained by subtracting the global median from each apparatus's mean and dividing by a global standard deviation. The server sorts the apparatuses by deviation score to generate rank information, and identifies low-performance apparatuses by applying threshold conditions to the deviation score and to error frequency. These threshold conditions are stored as numerical parameters in the server's configuration, not as hard-coded logic, enabling the server to adjust behavior at runtime.

The server generates prompt sentences for a generative AI model based on structured information that includes personnel information, evaluation information, target information, progress information, production efficiency information, operation index information, relative performance information, and low-performance apparatus identification information. The server implements a prompt-construction module that assembles template phrases and inserts numerical values and categorical labels into defined slots. In one configuration, the prompt sentence is constructed in a natural language, and explicitly instructs the generative AI model to perform comparison, diagnosis, and recommendation generation.

The server may, for example, generate a prompt sentence of the following form:
“Using the following machine performance data: Robot A produces an average of 100 units per hour with a 1% error rate, and Robot B produces an average of 80 units per hour with a 3% error rate under the same shift conditions. As a manufacturing productivity consultant, compare the two robots, identify why Robot B is less efficient, and propose three specific operational actions to improve Robot B's performance.”

The server may also generate a prompt sentence for evaluating organizational units, such as:
“Compare the number of parts assembled per hour by Robot A and Robot B, identify which robot is more efficient, and explain what operational changes should be considered for the less efficient robot.”

And the server may generate a prompt sentence for integrating human-related data and apparatus-related data, such as:
“Using the latest performance data, progress data, and machine efficiency data for Team X, calculate a monthly pseudo-evaluation for each member and propose task reassignments that would improve overall throughput.”

The server transmits the generated prompt sentence to a generative AI model hosted locally or on a remote compute resource. In one embodiment, the generative AI model is implemented as a neural network model having a transformer architecture with multiple self-attention layers, feed-forward layers, and layer normalization. The model parameters have been obtained through pre-training on large corpora of general text, and optionally fine-tuning on domain-specific text describing industrial operations. The server passes the prompt sentence to the model along with configuration parameters such as maximum output length, sampling temperature, and top-k or top-p constraints, so that the generation behavior can be controlled programmatically.

The server receives natural-language output from the generative AI model and converts this output into machine-usable structures. The server implements a parsing module that detects key phrases, enumerated lists, and numeric suggestions in the natural-language text. For example, if the generative AI model outputs a paragraph containing “First, reduce the workload of Robot B during night shifts; second, inspect sensors for misalignment; third, adjust maintenance intervals to every two weeks,” the server segments the paragraph into three action items, labels them as workload adjustment, sensor inspection, and maintenance scheduling, and assigns each item a category code. The server also extracts any explicit numeric values, such as “every two weeks,” and stores them as structured parameters. This structured representation is used as advice information and pseudo-evaluation information, and is distinct from the free-form natural-language output.

The server structures the production efficiency information, the relative performance information, and the structured data extracted from the generative AI model as visualization data. The server uses a visualization configuration that specifies, for each metric or advice category, chart types, axes, units, and color codes. The server builds an internal representation of charts, such as lists of data series, axes metadata, and style parameters, that can be directly rendered by a visualization library. By precomputing these structures on the server side, the system reduces the amount of data transmitted over the network and decreases rendering load on terminal devices.

The server generates list display information and detailed display information based on the visualization data, and transmits these to terminal devices. A terminal can be implemented as a smartphone, a tablet, or a workstation with a graphical user interface. The server and the terminal communicate using a web protocol over a secure channel. The terminal renders the received list display information as overview dashboards containing, for example, ranked lists of apparatuses with efficiency metrics and pseudo-evaluations. The terminal renders detailed display information as charts and text panels when the user selects a specific apparatus or organizational unit.

The user views these displays on the terminal, and can issue selection and configuration operations. Operations include selection of an apparatus, selection of an organizational unit, and designation of a time period for which data are to be viewed. The terminal sends these operations to the server as interaction events. The server interprets the events and uses them to filter the underlying time-series data and metrics. For example, if the user selects an apparatus and a time period, the server extracts the corresponding subset of time-series data, recomputes relevant aggregations if needed, and updates the detailed display information accordingly. This dynamic filtering and recomputation on the server allows the system to respond quickly to user requests without recalculating global metrics unnecessarily, thereby reducing processor load and improving response time.

The server monitors the production efficiency information, the relative performance information, and the progress information against predetermined performance-degradation conditions and delay conditions. These conditions are defined in terms of explicit inequalities or logical expressions over metrics, such as “efficiency below 80% of the median for three consecutive hours” or “progress below 50% while elapsed time exceeds 75% of planned time.” When the metrics satisfy one or more conditions, the server automatically generates a new prompt sentence that describes the anomaly and provides contextual data. For instance, the server may form a prompt sentence such as:
“Over the last 7 days, Machine C has an average efficiency of 60 units per hour, which is 30% lower than the median efficiency of comparable machines, and has experienced frequent sensor errors during the night shift. Analyze the likely technical causes of this performance degradation and propose detailed remediation steps prioritized by impact on efficiency.”

The server then re-invokes the generative AI model with this prompt sentence, collects the output, and merges the new advice into the visualization data, so that the terminal displays guidance that is tailored to the detected condition. This closed-loop behavior, in which model output influences subsequent prompt construction and metric recomputation, improves the adaptiveness of the system compared to approaches that simply call a generative model on static prompts.

The server uses specific internal data structures and algorithms to achieve technical effects. For example, the server organizes integrated time-series data into columnar storage, with separate contiguous arrays for timestamps, apparatus identifiers, production quantities, and runtime values. The server groups records by apparatus and time window using index arrays instead of repeated string comparisons, which yields improved cache coherence and fewer memory allocations. For performance ranking, the server computes deviations using vectorized arithmetic operating on entire columns in one pass, reducing the number of iterations and branch operations. These choices provide measurable reductions in processing time and energy consumption, especially when data volumes are large.

The server implements a generative AI model interface that batches multiple prompt sentences and submits them together to the model. The server maintains a queue of pending prompts, and when the queue reaches a size or age threshold, the server transmits them in a single batch. The model processes the batch in parallel on a hardware accelerator. This reduces the number of network round-trips and amortizes model initialization overhead, leading to lower latency and reduced network traffic compared to issuing separate calls for each user query. The batching algorithm is parameterized so that the server can balance latency and throughput depending on the deployment environment.

The generative AI model itself, in one embodiment, is implemented as a transformer-based neural network with multiple encoder-decoder blocks or decoder-only blocks. Each block includes self-attention layers with key, query, and value projections, and feed-forward layers with non-linear activation functions. The model is trained using a language modeling objective that minimizes cross-entropy loss between predicted tokens and target tokens. During fine-tuning, the training set includes domain-specific instructions and target responses about equipment diagnostics and performance optimization. The training process uses a gradient-based optimization algorithm, such as stochastic gradient descent with adaptive step sizes. The server, when fine-tuning is performed on-site, orchestrates the training by loading mini-batches of tokenized prompt-response pairs, computing forward and backward passes, updating weights, and tracking convergence metrics. This allows the generative AI model to provide more accurate and context-relevant outputs for the particular factory or organization.

The server further implements a rule-based post-processing module that differs from conventional manual reading of model outputs. This module applies deterministic pattern-matching rules and thresholding logic to convert free-form text into structured advice and pseudo-evaluations. For example, if the model output includes language indicating high severity, the server assigns a higher urgency code to the corresponding recommendation. The rule set is designed to align model outputs with the server's internal representation, so that subsequent steps, such as ranking recommendations or scheduling maintenance, can be carried out automatically. This approach goes beyond human “reading” of model outputs, and instead improves technical processing by allowing the server to use generative outputs as inputs to further computation.

In another embodiment, the server uses a different type of generative AI model, such as a sequence-to-sequence model that operates on serialized versions of the time-series data and metadata. The server encodes the most recent time-series segment into a token sequence, attaches instruction tokens specifying the desired analysis, and decodes output tokens representing structured recommendations. In this variant, the server exploits the model's ability to directly capture temporal patterns, which can yield more accurate detection of subtle trends or anomalies. The server still constructs human-readable prompt sentences but may also include machine-readable annotations, such as tags indicating feature boundaries or normalization scales.

The system provides technical effects that are not achieved by conventional static dashboards or manual analysis. By automating the integration of multiple heterogeneous data sources into a unified time-series representation, the server reduces data duplication and eliminates inconsistencies that often arise when different systems export different sampling intervals or formats. The server's algorithms for aggregation and relative performance computation reduce computation time and memory consumption, enabling real-time or near-real-time operation on commodity hardware. The prompt-generation module and model-interface module reduce the cognitive and operational burden of manually crafting prompts, while also enabling consistent use of domain-specific terminology and constraints.

The combination of generative AI model and rule-based structuring module allows the server to generate recommendations that are both human-readable and machine-actionable. This dual representation supports automated downstream processing, such as automatic flagging of high-risk apparatuses, adjustment of alarm thresholds, or pre-allocation of maintenance slots, and thereby reduces human error and improves response speed. The integration of pseudo-evaluation information into the visualization data also enables more nuanced and dynamic performance assessment, rather than relying solely on fixed numeric targets.

The terminal, in these embodiments, acts as an interface device that receives display information and sends user operations, but does not perform the heavy computation. This division of labor allows low-power terminals, such as handheld devices, to participate in the system without needing to process large data sets locally. The terminal, however, plays an important role in the feedback loop, because the server tailors its computations and prompt construction based on the user's context, such as selected apparatuses and time ranges.

The user, by interacting with the terminal, indirectly guides the server's behavior, but the core improvements in processing—such as dynamic data aggregation, efficient metric computation, structured use of generative AI outputs, and anomaly-triggered prompt generation—are realized within the server as improvements to computer operation. The system therefore represents more than automation of a human workflow; it modifies and enhances how the computing system organizes data, invokes models, and generates decision-support information, resulting in improved processing speed, scalability, and analytical accuracy.

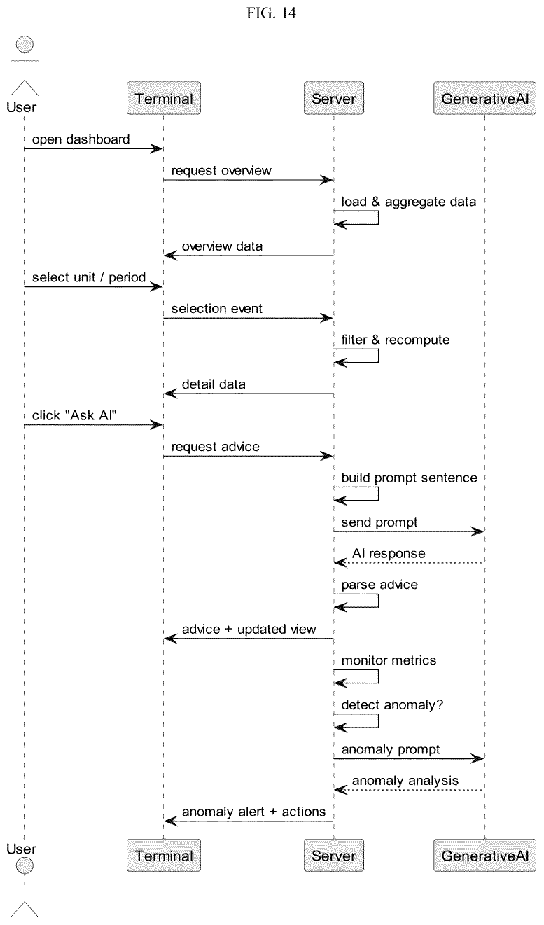

The following describes the processing flow using FIG. 14.

### Step 1:

Server acquires raw data from external systems and detection apparatuses.

Server receives, as input, personnel information, evaluation information, target information, and progress information from external information processing systems via APIs or database connections, and receives operation information from detection apparatuses attached to production apparatuses via industrial communication interfaces. Server parses incoming messages, validates required fields (IDs, timestamps, values), converts data types to internal formats, and stores each record into staging tables. Server outputs normalized raw records in a unified internal schema, with fields such as unit identifier, apparatus identifier, timestamp, metric type, and metric value.

### Step 2:

Server constructs integrated time-series data.

Server uses, as input, the normalized raw records from Step 1. Server groups records by apparatus identifier and organizational unit, aligns timestamps to predefined time intervals (for example, 5 minutes or 1 hour), and joins personnel-related records with apparatus-related records on overlapping time intervals. Server performs data processing such as filling missing values, discarding records with invalid timestamps, and assigning default values where external data is incomplete. Server outputs integrated time-series records in which each record includes, for a given interval and apparatus or unit, production quantity, runtime, error count, assigned personnel, target values, and progress values.

### Step 3:

Server aggregates integrated time-series data by unit time and apparatus.

Server uses, as input, the integrated time-series records from Step 2. Server aggregates the records by summing or averaging production quantities, runtimes, error counts, and progress values for each apparatus and time window. Server calculates derived fields such as total runtime per window, total output per window, and mean progress per window. The data processing includes applying grouping operations using apparatus identifiers and time window identifiers as keys. Server outputs aggregated time-series tables containing one row per apparatus per time window with consolidated metric values.

### Step 4:

Server computes production efficiency information and operation index information.

Server uses, as input, the aggregated time-series tables from Step 3. Server performs numerical operations to compute production efficiency, such as dividing production quantity by effective runtime, and computes operation indices, such as uptime ratio, downtime ratio, error rate, and approximated overall effectiveness using weighted formulas. Server applies vectorized arithmetic to entire columns, checks for division-by-zero conditions, and clamps extreme outliers to configured bounds. Server outputs metric tables in which each row includes apparatus identifier, time window, production efficiency, and multiple operation index values.

### Step 5:

Server calculates relative performance information and rank information.

Server uses, as input, the metric tables from Step 4. Server aggregates metrics across time, for example by computing average efficiency and average operation index per apparatus over a configurable period such as the last day or week. Server then calculates global reference values such as medians and standard deviations across all apparatuses, and computes deviation scores for each apparatus by comparing its average metrics to the global references. Server sorts apparatuses by deviation scores to derive rank positions and applies threshold rules to identify low-performance apparatuses. Server outputs relative performance information, including deviation scores, rank positions, and low-performance apparatus identification flags for each apparatus or unit.

### Step 6:

Server prepares structured input data for a generative AI model.

Server uses, as input, the relative performance information from Step 5 and contextual data including personnel information, target information, and progress information. Server selects key features, such as average efficiency values, error rates, rank positions, target achievement ratios, and recent trend indicators, and formats them into structured summaries. Server converts numerical values to human-readable expressions with units and rounding rules and creates context blocks describing conditions and time ranges. Server outputs structured context strings and feature sets ready to be embedded in a prompt sentence.

### Step 7:

Server generates a prompt sentence for the generative AI model.

Server uses, as input, the structured context strings and feature sets from Step 6. Server selects a prompt template based on the analysis objective, such as comparison analysis, anomaly diagnosis, or recommendation generation. Server fills template slots with context strings, feature summaries, and explicit instructions. For example, server may generate:
“Using the following machine performance data: Robot A produces an average of 100 units per hour with a 1% error rate, and Robot B produces an average of 80 units per hour with a 3% error rate under the same shift conditions. As a manufacturing productivity consultant, compare the two robots, identify why Robot B is less efficient, and propose three specific operational actions to improve Robot B's performance.”

Server outputs a complete prompt sentence as a text string.

### Step 8:

Server invokes the generative AI model with the prompt sentence.

Server uses, as input, the prompt sentence from Step 7. Server packages the prompt sentence into a request payload, sets generation parameters such as maximum token length and sampling temperature, and sends the payload to a generative AI model endpoint over a network connection. Server handles authentication, retries on failure, and logging of request metadata. Server receives natural-language output from the generative AI model as a response. Server outputs the raw model response text associated with the corresponding prompt and apparatus or unit identifiers.

### Step 9:

Server parses the natural-language output into structured advice and pseudo-evaluation information.

Server uses, as input, the raw model response text from Step 8. Server applies text-analysis routines, such as pattern matching for enumerated lists, keyword detection for action verbs, and numeric extraction for thresholds and intervals. Server segments the text into discrete recommendations, labels each recommendation with categories (for example, workload adjustment, maintenance scheduling, sensor inspection), and assigns severity or priority based on detected language cues. Server also derives pseudo-evaluation values where the text expresses relative performance or qualitative ratings, mapping them to numeric scales or categorical levels. Server outputs structured advice records and pseudo-evaluation records linked to apparatus or unit identifiers.

### Step 10:

Server constructs visualization data for list and detailed displays.

Server uses, as input, the metric tables, relative performance information, structured advice records, and pseudo-evaluation records from Steps 4, 5, and 9. Server selects and organizes metrics and advice into data series suitable for list views and detailed charts, including rank lists, trend lines, and categorized recommendation tables. Server assigns visualization attributes such as colors, axis labels, and legends and composes layout descriptors describing how charts and text should be arranged on the screen. Server outputs visualization data objects that encapsulate all numeric values, labels, and layout information needed for rendering.

### Step 11:

Server transmits list display information to the terminal.

Server uses, as input, the visualization data objects for overview information from Step 10. Server serializes these objects into a response format, such as a structured text or markup, and sends them to the terminal over a secure communication channel. Server may compress the data and filter out non-visible fields to minimize network traffic. Server outputs a response payload that includes rank lists, key metrics per apparatus or unit, and summarized advice snippets for each entry.

### Step 12:

Terminal renders an overview dashboard and accepts user operations.

Terminal uses, as input, the response payload from Step 11. Terminal parses the payload, constructs visual elements such as tables, charts, and clickable entries, and displays an overview dashboard on a graphical user interface. Terminal allows the user to perform operations, such as selecting a particular apparatus or unit, specifying a time period, or pressing a control labeled “Ask AI for details.” Terminal outputs user interaction events that include selected identifiers, selected time ranges, and requested operations.

### Step 13:

Server updates detailed display information based on user selections.

Server uses, as input, the user interaction events from Step 12. Server identifies the selected apparatus or unit and the specified time period, filters the time-series data and metrics accordingly, and recomputes, if necessary, local aggregates such as time-window averages or recent-trend slopes. Server selects advice records and pseudo-evaluation records corresponding to the selected context and composes detailed visualization data including fine-grained charts, such as hourly efficiency curves, and full recommendation texts. Server outputs updated detailed display information ready for transmission to the terminal.

### Step 14:

Server transmits detailed display information to the terminal.

Server uses, as input, the updated detailed display information from Step 13. Server encodes the detailed charts, labels, and full advice texts and sends them to the terminal using a response message triggered by the user's selection. Server ensures that the message includes identifiers that allow the terminal to replace or augment the currently visible details section. Server outputs a payload containing detailed metric series and associated natural-language recommendations.

### Step 15:

Terminal displays detailed metrics and AI-generated recommendations.

Terminal uses, as input, the payload from Step 14. Terminal renders detailed charts showing, for example, time-series plots of efficiency and error counts and text panels containing the AI-generated recommendations parsed by the server. Terminal synchronizes chart highlighting and text sections so that when the user focuses on a specific time interval or recommendation, the interface emphasizes corresponding visual elements. Terminal outputs visual feedback to the user and may generate further interaction events if the user requests additional analysis.

### Step 16:

Server monitors metrics against performance-degradation and delay conditions.

Server uses, as input, the metric tables and progress information from previous steps. Server periodically evaluates configured conditions over recent time windows, such as checking if an apparatus's efficiency stays below a percentage threshold of the median for multiple consecutive windows, or if progress remains below a required proportion of planned progress. Server applies logical expressions to metric values and determines which apparatuses or units satisfy one or more conditions. Server outputs condition evaluation results, including lists of affected apparatuses and condition types, as triggers.

### Step 17:

Server generates anomaly-specific prompt sentences and obtains additional analysis.

Server uses, as input, the condition evaluation results from Step 16 and corresponding metric histories. For each anomaly, server composes an anomaly-focused prompt sentence, for example:
“Over the last 7 days, Machine C has an average efficiency of 60 units per hour, which is 30% lower than the median efficiency of comparable machines, and has experienced frequent sensor errors during the night shift. Analyze the likely technical causes of this performance degradation and propose detailed remediation steps prioritized by impact on efficiency.”

Server submits these prompt sentences to the generative AI model in batches, using the same invocation mechanism as in Step 8, and receives natural-language analyses and remediation proposals. Server outputs refined advice records that capture anomaly-specific guidance.

### Step 18:

Server incorporates anomaly-specific guidance into visualization data and refreshes displays.

Server uses, as input, the refined advice records from Step 17 and existing visualization data. Server merges anomaly-specific guidance with general recommendations, updates urgency or priority indicators for affected apparatuses or units, and, if required, modifies color-coding or alert icons in the list and detailed views. Server then regenerates the relevant visualization data and transmits incremental updates to terminals. Server outputs updated display content that highlights anomalies and their corresponding remediation instructions.

### Step 19:

User reviews recommendations and takes real-world actions.

User uses, as input, the detailed metrics, rankings, and recommendations displayed on the terminal in Steps 12, 15, and 18. User interprets which apparatuses or units show consistent underperformance, which conditions have been triggered, and what operational or maintenance actions are suggested. User may, for example, schedule maintenance, reassign personnel, adjust operating parameters on equipment controllers, or change production plans, using separate control interfaces or management tools. User outputs decisions and actions that apply the server's computed and AI-assisted guidance to the real-world production environment.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

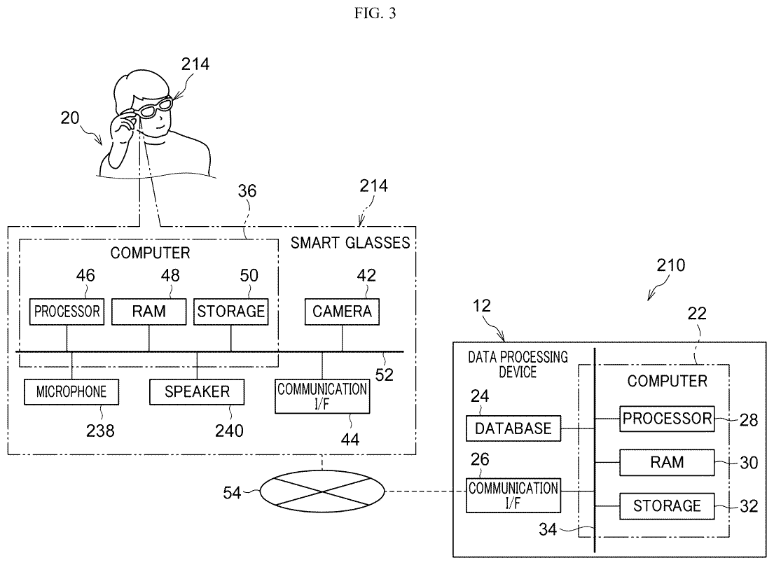

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

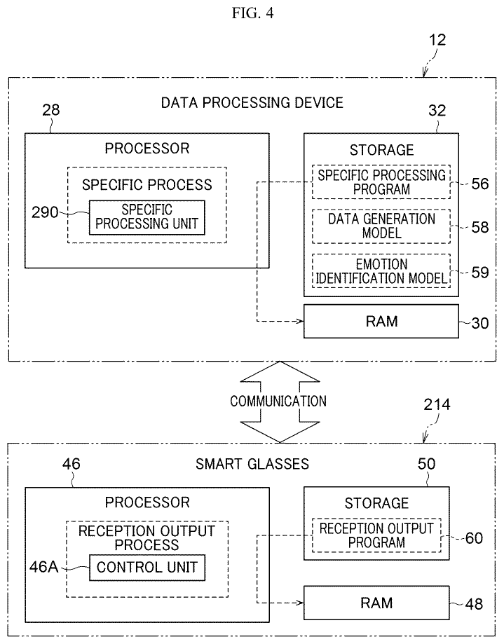

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

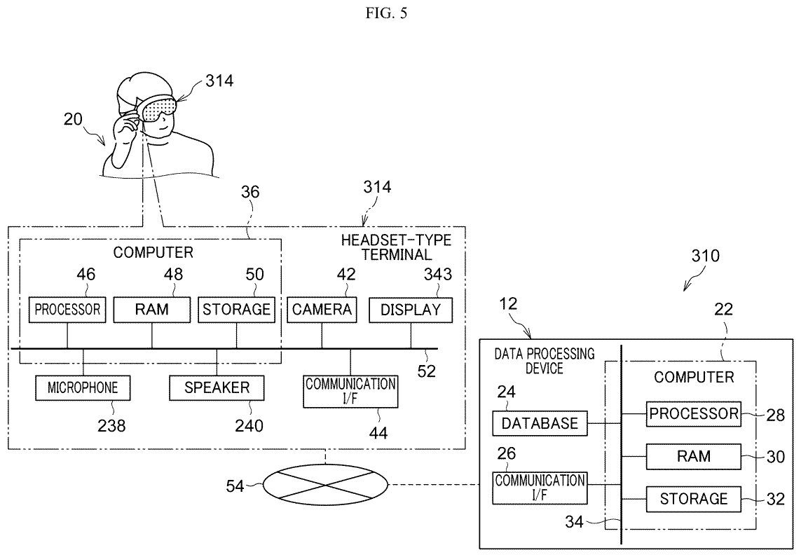

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

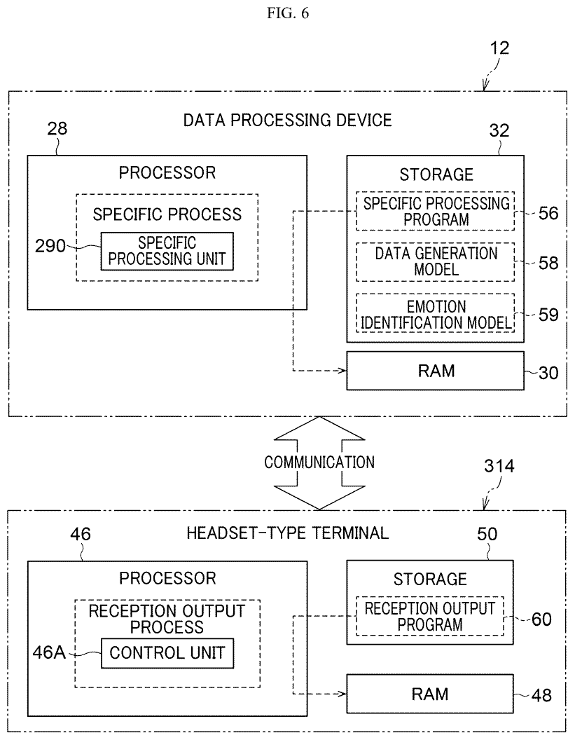

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

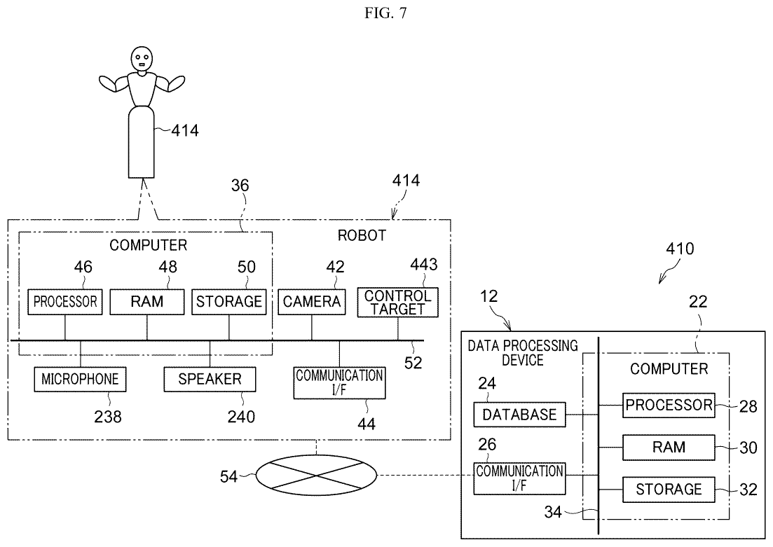

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

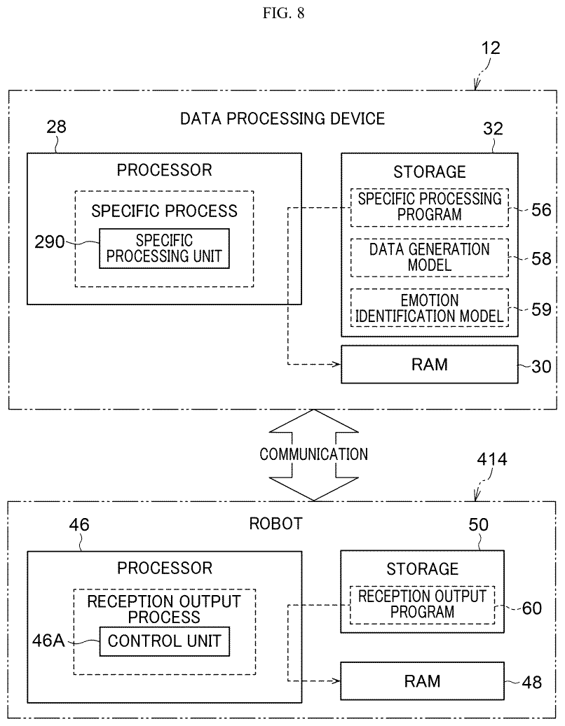

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

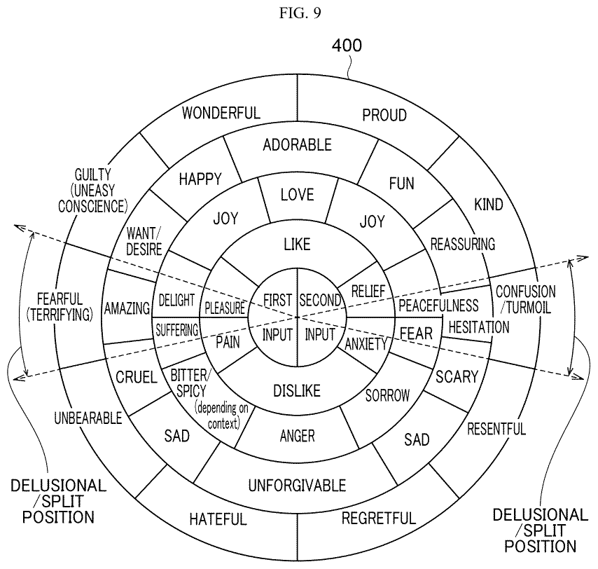

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

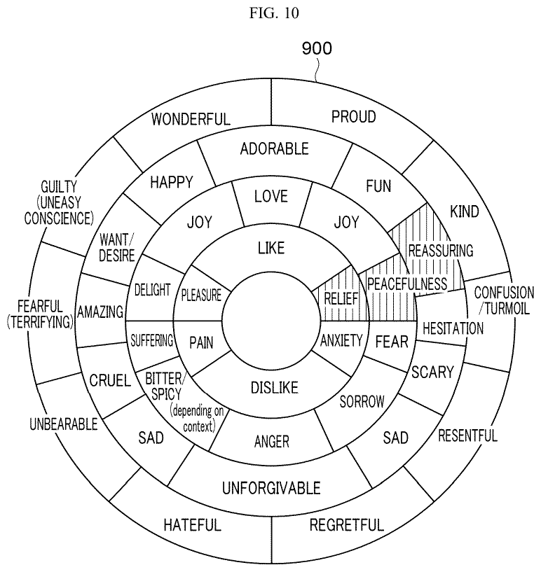

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, via a communication unit, data groups for each member of an organization from a plurality of information processing devices including an information processing device that holds management information of the members, an information processing device that evaluates activity results of the members, an information processing device that sets goals of the members, an information processing device that analyzes work progress of the members, and an information processing device that performs prediction or classification based on a learning algorithm, and integrate the data groups to accumulate them as stored data in a storage unit,
perform data structure conversion processing and feature generation processing on the stored data, construct an estimation model based on the learning algorithm, and calculate prediction information regarding at least one of goal achievement probability and work efficiency of each member by using the estimation model,
generate, based on the stored data and the prediction information, an analysis context including evaluation indices, goal achievement status, progress status, and risk factors for each member, and create a prompt sentence including the analysis context and an instruction sentence received from a user,
input the prompt sentence into a generative AI model that generates a response sentence expressed in natural language, and cause the generative AI model to perform at least one of analysis, explanation, and advice generation based on the analysis context,
generate, based on the response sentence obtained from the generative AI model and the prediction information, visual display data that presents at least one of evaluation results, goal achievement probabilities, work delay risk levels, and improvement proposals for each member by using at least one of graphical elements and list elements, and provide the visual display data to a terminal device for presentation to the user, and
update, in response to additional input from the user received from the terminal device, content of the prompt sentence and repeatedly input the updated prompt sentence into the generative AI model to perform interactive analysis or advice generation.

### Supplementary 2

The system according to supplementary 1,
wherein the processor is configured to
generate the prompt sentence including an analysis context for calculating a relative evaluation value as a normalized comparison index based on statistical information, by using the stored data and the prediction information relating to other members belonging to the same organization as a target member, and cause the generative AI model to generate a response sentence including the relative evaluation value and an explanation of factors of the relative evaluation value.

### Supplementary 3

The system according to supplementary 1,
wherein the processor is configured to
periodically update the stored data and the prediction information at predetermined time intervals, generate the prompt sentence including a pseudo evaluation value for each member and an action proposal generated by the generative AI model, and present, via the terminal device, the pseudo evaluation value and the action proposal to the user so as to enhance behavioral motivation of the user and facilitate grasping of growth status of the members by a manager.

### Application Example 1

### Supplementary 1

A system comprising a processor,
wherein the processor is configured to
acquire human resource related information from an information processing apparatus group and integrate the human resource related information into unified data, compute work efficiency indicators based on the unified data, and identify delay degrees and problem locations for each work unit or work process unit,
dynamically generate a prompt sentence for a generative AI model according to the work efficiency indicators and the problem locations, and transmit input data including the prompt sentence to the generative AI model,
analyze output information obtained from the generative AI model, divide work procedure information and improvement proposal information into instruction units expressed as short sentences, and convert the instruction units into display control data by assigning priority information and display time information to each instruction unit,
transmit the display control data to a terminal apparatus including a portable visual display apparatus, and cause the terminal apparatus to sequentially display the work procedure information and the improvement proposal information within a worker's field of view,
acquire operation information and progress information of the worker transmitted from the terminal apparatus, recompute the work efficiency indicators using the operation information and the progress information, update contents of the prompt sentence, and re-execute input of the updated prompt sentence to the generative AI model so as to update advice contents in real time, and
compare the work efficiency indicators before and after application of advice provided by the generative AI model, and create, based on a comparison result, another prompt sentence for generating further improvement proposal information, and input the another prompt sentence to the generative AI model.

### Supplementary 2

The system according to supplementary 1,
wherein the processor is configured to
acquire, as the human resource related information from the information processing apparatus group, work progress information of a plurality of members, include in the prompt sentence conditions for calculating a pseudo evaluation value based on relative work achievement degrees among the plurality of members, generate relative pseudo evaluation information based on the output of the generative AI model, and present the relative pseudo evaluation information to a user via the terminal apparatus.

### Supplementary 3

The system according to supplementary 1,
wherein the processor is configured to
repeatedly generate the prompt sentence and cause the generative AI model to execute analysis or prediction at a predetermined cycle, and continuously provide, to the user, pseudo evaluation information and improvement proposal information calculated as a result thereof, thereby enhancing motivation of the user and facilitating growth management of members by a manager.

### Example 2

### Supplementary 1

A system comprising a processor,
wherein the processor is configured to
cooperate with a human resources information processing apparatus, a business performance information processing apparatus, a goal management information processing apparatus, a work progress information processing apparatus, and a machine learning information processing apparatus to acquire evaluation information, goal information, and work progress information of members, and to determine a target of analysis using the evaluation information,
acquire evaluation information regarding the members from an information storage apparatus configured to store the evaluation information, and execute preprocessing on the evaluation information, the preprocessing including completion of missing values, removal of abnormal values, and normalization processing based on statistical indicators by using data analysis software executed on a general-purpose program execution environment,
   use the preprocessed evaluation information as feature data to construct a learning model that performs neighbor-search-based classification processing, and calculate a relative pseudo-evaluation for each member by the learning model, while calculating a relative index by comparing an evaluation index of each member with a group average based on group statistical values,
convert the relative pseudo-evaluation and the relative index into graph display data, and generate evaluation result display information in which a relative position among the members is visually understandable on a display apparatus,
generate a prompt sentence that instructs a generative information processing model to calculate the relative pseudo-evaluation and an explanation thereof, and to generate the evaluation result display information, based on information acquired from the human resources information processing apparatus, the business performance information processing apparatus, the goal management information processing apparatus, the work progress information processing apparatus, and the machine learning information processing apparatus, and based on the relative pseudo-evaluation, and
execute, in accordance with processing procedure information or an executable program output by the generative information processing model in response to the prompt sentence, the preprocessing, the construction of the learning model, the calculation of the relative pseudo-evaluation, and the generation of the evaluation result display information automatically, and provide results of the execution to a user terminal.

### Supplementary 2

The system according to supplementary 1,
wherein the processor is configured to
execute the preprocessing on the evaluation information acquired for members in a unit of a division or a group, generate a prompt sentence for calculating a relative pseudo-evaluation including distance information and rank information with respect to other division members or group members by using the neighbor-search-based classification processing, calculate the relative pseudo-evaluation based on processing contents generated by the generative information processing model, and provide, to the user terminal, ranking information and visualization information using the relative pseudo-evaluation as a comparison index.

### Supplementary 3

The system according to supplementary 1,
wherein the processor is configured to
automatically generate the prompt sentence at a predetermined time interval or in response to an occurrence of an event, execute the preprocessing and the neighbor-search-based classification processing on latest evaluation information to calculate an updated relative pseudo-evaluation, and continuously provide, to the user terminal, the updated relative pseudo-evaluation and visualization information indicating a temporal change of the updated relative pseudo-evaluation, thereby enhancing motivation of a user and facilitating grasping and management of growth states of the members by a manager.

### Application Example 2

### Supplementary 1

A system comprising a processor,
wherein the processor is configured to
integrate personnel information, evaluation information, target information, and progress information acquired from a personnel information processing apparatus, an evaluation information processing apparatus, a target information processing apparatus, a progress information processing apparatus, and a learning information processing apparatus, with operation information acquired from a detection apparatus provided to a production apparatus, and to store the integrated information as time-series data and to aggregate the time-series data by unit time and by apparatus unit,
to execute numerical operations on the aggregated operation information so as to calculate production efficiency information and operation index information for each apparatus, to calculate relative performance information by comparing the production efficiency information and the operation index information among the apparatuses, and to generate rank information and low-performance apparatus identification information for each apparatus based on the relative performance information,
to generate a prompt sentence for a generative information processing model that performs natural language processing, the prompt sentence including at least a part of the personnel information, the evaluation information, the target information, the progress information, the production efficiency information, the operation index information, the relative performance information, and the low-performance apparatus identification information as input conditions, and to cause the generative information processing model to execute comparison analysis processing or prediction processing based on the prompt sentence,
to analyze natural-language output acquired from the generative information processing model, to extract improvement measure information for an apparatus, personnel allocation adjustment information, and work priority adjustment information, and to organize the extracted information as advice information, and to structure the advice information together with the production efficiency information and the relative performance information as visualization data,
to generate list display information and detailed display information including at least the production efficiency information, the relative performance information, and the advice information obtained from the generative information processing model, based on the visualization data, by using a display control program, and to transmit the list display information and the detailed display information to a terminal apparatus so that the list display information and the detailed display information are displayed as an interactive screen,
to receive apparatus selection operation information or period designation operation information from the terminal apparatus, and, in response to the apparatus selection operation information or the period designation operation information, to re-extract or recalculate the time-series data and the visualization data, and to cause updated production efficiency information, updated relative performance information, and updated advice information to be redisplayed on the terminal apparatus, and
to determine that a predetermined condition including a performance-degradation condition or a delay condition is satisfied when at least one of the production efficiency information, the relative performance information, and the progress information meets the predetermined condition, to automatically generate a prompt sentence including content of the predetermined condition and related apparatus information or related personnel information, and to trigger additional analysis processing or proposal generation processing by the generative information processing model based on the prompt sentence.

### Supplementary 2

The system according to supplementary 1,
wherein the processor is configured to
use progress information, production efficiency information, and relative performance information of other organizational units as comparison targets, to generate, for each organizational unit, a prompt sentence for the generative information processing model for calculating pseudo-evaluation information indicating a relative position with respect to the comparison targets, to acquire natural-language output from the generative information processing model based on the prompt sentence, to convert the natural-language output into numerical data and categorical data so as to calculate the pseudo-evaluation information, and to include the pseudo-evaluation information in the visualization data and cause the pseudo-evaluation information to be displayed on the terminal apparatus.

### Supplementary 3

The system according to supplementary 1,
wherein the processor is configured to
periodically update the time-series data, to recalculate the production efficiency information, the relative performance information, and the progress information, to periodically generate a prompt sentence based on the updated information, to cause the generative information processing model to periodically calculate pseudo-evaluation information and advice information based on the prompt sentence, and to continuously provide the pseudo-evaluation information and the advice information to a user via the terminal apparatus so as to maintain user motivation and to facilitate personnel management and apparatus operation management by a manager.

What is claimed is:

1. A system comprising:
circuitry configured to:
acquire, via a communication interface coupled to a packet-switched network, data groups from a plurality of external information processing apparatuses, and integrate the acquired data groups into stored data accumulated in a storage system;
perform data structure conversion processing on the stored data to generate multidimensional feature tensors, and input the multidimensional feature tensors into an estimation model constructed based on a learning algorithm to calculate prediction data including probability values and efficiency values;
generate analysis context data by combining the stored data and the prediction data into a structured data representation, and create an instruction sequence by concatenating the analysis context data with an instruction input received from a terminal device via the packet-switched network;
input the instruction sequence into a generative neural network model comprising a transformer-based architecture to cause the generative neural network model to generate a response output in natural language based on the analysis context data;
generate, based on the response output and the prediction data, display control data associating at least graphical rendering parameters with corresponding data fields of the prediction data, and transmit the display control data to the terminal device via the communication interface; and
receive, from the terminal device, additional input data, update the instruction sequence based on the additional input data, and re-input the updated instruction sequence into the generative neural network model to generate an updated response output.

2. The system according to claim 1, wherein the plurality of external information processing apparatuses include a first apparatus that maintains management information, a second apparatus that stores activity result information, a third apparatus that manages target information, a fourth apparatus that analyzes progress information, and a fifth apparatus that performs prediction or classification based on the learning algorithm.

3. The system according to claim 2, wherein the circuitry is further configured to:
integrate the acquired data groups by performing schema normalization to align data field formats across the plurality of external information processing apparatuses, timestamp alignment to synchronize temporal references, and entity linkage to associate records corresponding to a same entity across the data groups.

4. The system according to claim 3, wherein the circuitry is further configured to:
perform the data structure conversion processing by executing completion of missing values in the stored data, removal of abnormal values from the stored data, and normalization processing based on statistical indicators calculated from the stored data, and generate the multidimensional feature tensors from the processed stored data.

5. The system according to claim 4, wherein the circuitry is further configured to:
construct the estimation model as a neighbor-search-based classification model using the multidimensional feature tensors as training input, and calculate the prediction data including at least one of a goal achievement probability or a work efficiency value for each entity represented in the stored data.

6. The system according to claim 1, wherein the circuitry is further configured to:
create the instruction sequence by concatenating a system instruction portion specifying a generation role and an output format, an analysis context portion including the analysis context data, and a format constraint portion requiring the generative neural network model to output the response output with predefined delimiters separating analysis segments, explanation segments, and proposal segments.

7. The system according to claim 6, wherein:
the generative neural network model comprises a multi-layer self-attention architecture with multi-head attention sublayers and feed-forward sublayers, and the circuitry is configured to control decoding of the generative neural network model using a beam search algorithm with a temperature parameter and a maximum output length parameter.

8. The system according to claim 7, wherein the circuitry is further configured to:
parse the response output by detecting delimiter patterns in an output token sequence of the generative neural network model, and extract from the response output at least an analysis result segment, an explanation segment providing natural language interpretation of the prediction data, and a proposal segment including improvement recommendations.

9. The system according to claim 1, wherein the circuitry is further configured to:
generate the display control data by mapping the prediction data to graphical rendering parameters including axis label data, scale parameters, and data point coordinates for graph elements, and by associating the proposal segment extracted from the response output with corresponding list rendering parameters.

10. The system according to claim 9, wherein the circuitry is further configured to:
receive, from the terminal device, selection operation data indicating a selected entity or period designation data indicating a selected time range, re-extract a subset of the stored data based on the selection operation data or the period designation data, recalculate the prediction data from the re-extracted subset, and generate updated display control data reflecting the recalculated prediction data.

11. The system according to claim 10, wherein the circuitry is further configured to:
compare the prediction data calculated before and after application of proposals derived from the response output, and generate, based on a comparison result, a further instruction sequence for the generative neural network model to generate further improvement proposal information.

12. The system according to claim 1, wherein the circuitry is further configured to:
calculate, for each entity represented in the stored data, a relative index value by comparing an individual index value of the entity against a group statistical value including a group average computed from a plurality of entities in a same organizational grouping, and generate rank information indicating a relative position of each entity within the organizational grouping.

13. The system according to claim 12, wherein the circuitry is further configured to:
generate a relative evaluation instruction sequence that includes conditions for calculating a relative pseudo-evaluation using the neighbor-search-based classification model, input the relative evaluation instruction sequence into the generative neural network model, and acquire from the generative neural network model relative pseudo-evaluation information including distance information and rank information with respect to other entities in the organizational grouping.

14. The system according to claim 1, wherein the circuitry is further configured to:
automatically generate the instruction sequence at a predetermined time interval or in response to an occurrence of a predefined event, recalculate the prediction data from latest stored data acquired from the plurality of external information processing apparatuses, and re-input the instruction sequence into the generative neural network model to generate periodically updated response outputs.

15. The system according to claim 14, wherein the circuitry is further configured to:
acquire operation information and progress information transmitted from the terminal device, recompute the efficiency values in the prediction data using the operation information and the progress information, update the instruction sequence to reflect the recomputed efficiency values, and re-input the updated instruction sequence into the generative neural network model to update advice contents in real time.

16. The system according to claim 1, wherein the circuitry is further configured to:
analyze the response output to divide content of the response output into instruction units expressed as short sentences, assign priority information and display time information to each instruction unit, convert the instruction units into sequential display control data, and transmit the sequential display control data to a portable visual display apparatus to cause the portable visual display apparatus to sequentially display the instruction units within a field of view of a user.

17. The system according to claim 16, wherein:
the plurality of external information processing apparatuses comprise a personnel management device, a performance evaluation device, a goal setting device, and a work progress analysis device of an organization, the stored data includes evaluation information, goal information, and work progress information of employees of the organization, the prediction data includes pseudo-evaluation information for each employee, and the display control data is configured to present the pseudo-evaluation information to increase motivation of the employees and to facilitate management of growth of subordinates by a manager.

18. A system comprising:
circuitry configured to:
acquire, via a communication interface coupled to a packet-switched network, data groups including operation data from a detection apparatus coupled to a production apparatus and information data from a plurality of information processing apparatuses, and store the acquired data groups as time-series data in a storage system;
aggregate the time-series data by unit time and by apparatus unit, execute numerical operations on the aggregated data to calculate production efficiency information and operation index information for each apparatus, and calculate relative performance information by comparing the production efficiency information and the operation index information among a plurality of apparatuses;
generate rank information and identification information for apparatuses having performance values below a threshold based on the relative performance information, and generate a prompt sentence for a generative neural network model comprising a transformer-based architecture, the prompt sentence including at least the production efficiency information, the operation index information, the relative performance information, and the identification information as input conditions;
input the prompt sentence into the generative neural network model to cause the generative neural network model to perform comparison analysis processing or prediction processing, and analyze a natural language output from the generative neural network model to extract improvement measure information, allocation adjustment information, and priority adjustment information; and
structure the extracted information together with the production efficiency information and the relative performance information as visualization data, generate display information based on the visualization data, and transmit the display information to a terminal apparatus via the communication interface.

19. The system according to claim 18, wherein the circuitry is further configured to:
determine that a predetermined condition including a performance degradation condition or a delay condition is satisfied when at least one of the production efficiency information, the relative performance information, or progress information meets the predetermined condition, automatically generate an additional prompt sentence including content of the predetermined condition and related apparatus identification information, and trigger additional analysis processing by the generative neural network model based on the additional prompt sentence.

20. A method performed by circuitry of a system, the method comprising:
acquiring, via a communication interface coupled to a packet-switched network, data groups from a plurality of external information processing apparatuses, and integrating the acquired data groups into stored data accumulated in a storage system;
performing data structure conversion processing on the stored data to generate multidimensional feature tensors, and inputting the multidimensional feature tensors into an estimation model constructed based on a learning algorithm to calculate prediction data including probability values and efficiency values;
generating analysis context data by combining the stored data and the prediction data into a structured data representation, and creating an instruction sequence by concatenating the analysis context data with an instruction input received from a terminal device via the packet-switched network;
inputting the instruction sequence into a generative neural network model comprising a transformer-based architecture to cause the generative neural network model to generate a response output in natural language based on the analysis context data;
generating, based on the response output and the prediction data, display control data associating at least graphical rendering parameters with corresponding data fields of the prediction data, and transmitting the display control data to the terminal device via the communication interface; and
receiving, from the terminal device, additional input data, updating the instruction sequence based on the additional input data, and re-inputting the updated instruction sequence into the generative neural network model to generate an updated response output.
